(19) United States
(12) Patent Application Publication
(10) Pub. No.: US 2013/0147711 A1
(43) Pub. Date: Jun. 13, 2013

(54) CAMERA-BASED MULTI-TOUCH INTERACTION APPARATUS, SYSTEM AND METHOD

(71) Applicants: Tormod Njolstad, Trondheim (NO); Hallvard Naess, Trondheim (NO); Oystein Damhaug, Trondheim (NO)

(72) Inventors: Tormod Njolstad, Trondheim (NO); Hallvard Naess, Trondheim (NO); Oystein Damhaug, Trondheim (NO)

(73) Assignee: EPSON NORWAY RESEARCH AND DEVELOPMENT AS, Trondheim (NO)

(21) Appl. No.: 13/814,832

(22) PCT Filed: Nov. 22, 2011
(86) PCT No.: PCT/NO2011/000328

§ 371 Date: Feb. 7, 2013

Related U.S. Application Data
(60) Provisional application No. 61/416,178, filed on Nov. 22, 2010.

(30) Foreign Application Priority Data
Dec. 14, 2010 (GB) 1021213.2

(51) Int. Cl. G06F 3/01

(52) U.S. Cl. CPC G06F 3/011
USPC 345/158

(57) ABSTRACT

An apparatus, system and method controls and interacts within an interaction volume within a height over the coordinate plane of a computer such as a computer screen, interactive whiteboard, horizontal interaction surface, video/web-conference system, document camera, rear-projection screen, digital signage surface, television screen or gaming device, to provide pointing, hovering, selecting, tapping, gesturing, scaling, drawing, writing and erasing, using one or more interacting objects, for example, fingers, hands, feet, and other objects, for example, pens, brushes, wipers and even more specialized tools. The apparatus and method be used together with, or even be integrated into, data projectors of all types and its fixtures/stands, and used together with flat screens to render display systems interactive. The apparatus has a single camera covering the interaction volume from either a very short distance or from a larger distance to determine the lateral positions and to capture the pose of the interacting object(s).

### FIELD OF THE INVENTION

The present invention relates to camera-based multi-touch interactive systems, for example utilizing camera-based input devices and visual and/or infrared illumination for tracking objects within an area/space, for example for tracking one or more fingers or a pen for human interaction with a computer; the systems enable a determination of a two-dimensional position within an area and a height over a surface of the area, for providing actual two-dimensional input coordinates and for distinguishing precisely between actual interaction states such as “inactive” (no tracking), “hovering” (tracking while not touching, sometimes also labelled “in range”) and “touching”. The present invention also relates to multi-modal input devices and interfaces, which, for example, allow both pen and finger touch input, and also is operable to cope with several objects concurrently, for example a multi-touch computer input device. Moreover, the invention concerns methods of inputting gesture using three-dimensional based input devices and thereby capturing a human posture of, for example, a hand or a finger, and sequences of these can be recognized as gesture commands and/or position and orientation inputs for three-dimensional control.

### BACKGROUND OF THE INVENTION

Camera based tracking of objects for human interaction with computers, in particular tracking of the hands and fingers, has attained scientific, industrial and commercial interest over several decades. Reviews of achievements in this computational intensive field is given by Pavlovic et al, IEEE Trans. Pattern Analysis and Machine Intelligence, vol 19, No. 7, pp. 677-695,1997, and by Zhou et al., IEEE Int. Symposium on Mixed and Augmented Reality, pp. 193-202, 2008. In many of the reported techniques, the objects are observed from several different viewpoints by one or more cameras to reduce the susceptibility of occlusions and for robust tracking and gesture interpretation.

For single camera based tracking of finger touch and finger or hand gestures, features like shadows, contours, texture, silhouette and image gradients of these objects, and even their mirror image reflected back from a glossy display surface, are extracted and utilized to update the different model-based tracking systems to compute the finger or hands posture and to detect, for example, finger touching in real-time.

As an example of clever feature extraction, US2010/0066675A1 describes a single camera imaging touch screen system and feature extraction based on the observation that the shadow from a finger illuminated by a sideway illuminant is ultimately obscured by the finger when touching the screen, such that the shadow resembles a finger when not touching, while the shadow is narrowed substantially when the finger is touching the surface such that touch can be determined. The independent claim, however, is anticipated by a public scientific article from 2005 by the inventor Andrew D. Wilson (ACM Proc. UIST 2005, pp 83-92).

The WO09940562 (A1), US006100538A and US2010188370 (A1) are in principal describing object tracking systems for finger touch or pen where the at least two camera viewpoints are disposed at the periphery of the coordinate plane to determine the coordinates of the object by triangulation.

WO09940562 (A1) describes a system for detecting pen and finger touch in front of a computer monitor screen by using a single camera and by a periscope-like optical system consisting of one or several flat mirrors, recording two images of the screen looking sideways into the volume immediately in front of the screen, to determine the pen or finger's coordinates and distance to screen.

US006100538A describes an optical digitizer for determining a position of a pointing object projecting a light and being disposed on a coordinate plane, and a detector disposed on the periphery of the coordinate plane, preferably a pair of linear image sensors, has a field-of-view covering the coordinate plane, and a collimator is disposed to limit the height of the view field of the detector and the detector can receive only a parallel component of the light which is projected from the pointing object substantially in parallel to the coordinate plane, and a shield is disposed to block noise light other than the projected light from entering into the limited view field of the detector, and a processor is provided for computing the coordinates representing the position of the pointing object.

US2010188370 (A1) describes a camera-based touch system including at least two cameras having overlapping fields, placed along the periphery and typically in the corners of the touch surface to detect the position of the pointer by triangulation, and to detect the pointer touch and pointer hover above the touch surface.

The JP63292222 and US2008152192 (A1) are in principal using a camera distant located from the object and using one or more flat mirrors within the camera's field-of-view observe the object from different viewpoints and directions substantially perpendicular to the camera axis to simplify the detection of the object's position.

JP63292222 uses a single camera distant from a writing surface and two flat narrow mirrors along the periphery of said writing surface in each of the two directions X and Y tilted towards the said surface to obtain alternative viewpoints of the pointing device, which make it possible to obtain the X and Y coordinate separately by capturing and analyzing the two mirror regions along the writing surface region.

US2008152192 (A1) describes a system for 3-D monitoring and analysis of motion-related behavior of test subjects, namely fish and animals. It comprises an actual camera and at least one virtual camera, realized by using at least one flat mirror within the field-of-view of the actual camera, representing at least one alternative viewpoint which can be analyzed in one or more regions of the captured camera image, to be able to analyze the motion behavior of the test objects.

In a published international PCT patent application no. WO2005/034027(A1) (Smart Technologies Inc.), there is described an apparatus for detecting a pointer within a region of interest. The apparatus includes a first reflective element extending along a first side of the region of interest and operable to reflect light towards the region of interest. Moreover, the apparatus includes a second reflective element extending along a second side of the region of interest which is also operable to reflect light towards the region of interest. The second side is joined to the first side to define a first corner of the apparatus. A non-reflective region generally in a plane of at least one of the first and second reflective elements is adjacent to the first corner. At least one imaging device is operable to capture images of the first region of interest including reflections form the first and second reflective elements, for determining a position of the pointer within the region of interest.

In a published Japanese patent application no. JP63292222(A) (Mitsubishi Electric Corp.), there is described an optical system which is operable to detect a coordinate position of a point indicator. The optical system functions by forming an image in a neighborhood of an upper plane relative a corresponding original object. There is also included a processing arrangement for processing a picture signal obtained from an image sensing device disposed in the neighborhood of the upper plane. More particularly, the image sensing device senses an image pickup area including a read origin. There is also included an X-direction reflecting mirror and a Y-direction reflecting mirror. The point indicator, for example a write pen, is sensed directly by the image sensing device and also via reflection from the mirrors, so that the picture signal for determining a spatial position of the point indicator within the optical system.

Moreover, in a published Japanese patent no. JP4484796(B2) (Canon KK), there is described a coordinate input apparatus for accurately detecting a coordinate inputted thereto. The apparatus includes a plurality of sensor units disposed around a coordinate input area, wherein each of the sensor units includes a projection part for projecting light radiation onto the coordinate input area and a light receiving part for receiving incoming light at the sensor unit. The apparatus also includes a plurality of recursive reflection parts providing recursively reflected incident light provided on a periphery of the coordinate input area. The apparatus is operable to calculate a coordinate of pointing position of a pointer, based on light quantity distributions including light shielding areas which are obtained from the plurality of sensor units. A three-dimensional light shielding detection area pertaining to the plurality of sensor units has a common three-dimensional shape corresponding to the coordinate input area. Moreover, the three-dimensional light shielding detection area is defined as a three-dimensional area in which a change in height-directional position of the pointer is detected by a change rate of light intensity as detected by the plurality of sensor units.

In a Japanese patent no. JP4033802(B2) (Advanced Telecomm Research Institute), there is described a large screen touch panel system allowing touch input of information. The system includes a plastics material screen which is irradiated by an infrared source in operation from a front side of the screen. In operation, a person touches the screen manually suing their hand. Moreover, a camera of the system photographs a rear side of the screen via a mirror to generate photographic data which is provided to a computer. On a basis of the photographic data, a shaded area resulting from person's hand intercepting the infrared radiation is detected by the computer by processing the photographic data. When the shaded area has a spatial extent corresponding to a size of the hand for example, the coordinates of the shaded area are determined for deriving a measure of a spatial position of the person's hand in respect of the screen.

In general, it is important that the user's intentions and commands are correctly recognized in man-machine interaction systems. The accuracy of the X and Y in the coordinate plane may, or may not, be important. This is dependent on the application. Consequently, finger touch systems are attractive where modest accuracy is required for, for example, moving or selecting graphical objects or accessing menus, while a stylus or a pen is preferred when the highest accuracy is required, for example, fine writing or drawing, or handling all details and objects in CAD-programs. Therefore, in a finger based system, feature extraction and robust heuristics for the determination of the finger's coordinates may be sufficient, based on a two dimensional image from a single camera.

However, for all type of applications, high precision related to detection of finger or pen touching is of outmost importance, and must never fail, because then the user may lose control over the application. A high and constant detection quality of the touching condition is therefore required in every position in the coordinate plane. The detection method should furthermore not be susceptible to variations in finger size, skin color, ambient light conditions, display light etc., and the detection should be fast. Therefore, a good user interaction is designed to ensure high quality, high robustness and high speed of the finger/pen touch detection even if coordinate resolution accuracy is modest, and the best system will be able to provide the object's physical height with constant scaling over the complete coordinate plane, thus determining both the touching and hovering condition uniformly over the coordinate plane, and without any user-dependent behavior or delay penalty.

For the determination of posture, scaling is not so important. The ratios of the distance between different features observed within a single image may, for example, be sufficient for determining that the actual object is a hand, with, for example, a straight thumb and a straight index finger, while the other fingers are hidden. It is not important whether it is a large hand of a man or a small hand of a child, or whether it is large because it is close to the camera lens, or small because it is more distant. By tracking the relative movements and the accompanying types of postures as can be determined from image to image, such sequences can be interpreted as hand gesture commands, which to some extent are incorporated in user interfaces for computers, mobile devices and embedded systems.

There is a great interest in interaction systems using pen, touch or both (dual-mode systems) for education, collaboration and meetings. Operating systems and graphical user interfaces prepared for dual-mode multi-touch and multi-pen input, distinguish between touch, pen and mouse input, and therefore the dual-mode input devices must report information of multi-touch, multi-pen and mouse information concurrently to the computer. Several new interaction platforms also allow simple pen or finger gesture control, and/or even hand gesture based interaction.

Specifically, there is a great global interest in interactive tablets and whiteboards for use within education both in the normal classrooms and in the large lecture halls. Such whiteboards are also entering the meeting rooms, video conferencing rooms and collaboration rooms. The images on the interactive whiteboard's coordinate plane may be generated as a projected image from a short-throw or long-throw data projector, or by a flat screens as LCD display, plasma display, OLED display or rear-projection system. It is important that the input device for touch and/or pen can be used together with all types of display technologies without reducing the picture quality or wearing out the equipment. It is furthermore important that input device technology can be easily adopted to different screens, projectors and display units with low cost and effort.

New interactive whiteboard is commonly equipped with short-throw projectors, namely projectors with an ultra wide-angle lens placed at short distance above the screen. By this solution the user will be less annoyed by light into his/her eyes and will tend to cast less shadows onto the screen, and the projector can be mounted directly on the wall together with the board. An ideal input device for pen and touch for such short-throw systems should therefore be integrated into or attached alongside the wall projector, or attached to the projector wall mount, to make installation simple and robust.

In lecture halls, very long interactive whiteboards and interaction spaces are required, and these interaction surfaces should provide touch, pen and gesture control. On large format screens, pointing sticks and laser pointers are often required to draw the public's attention. The preferred input technology should apt to all such diverse requirements, i.e. also accept pointing sticks and lasers as a user input tool, and be tolerant to and adaptable to different display formats.

Also flat screen technologies may need touch and/or pen operation, simple pen and/or touch gesture interaction, and ultimately hand gesture control. Touch sensitive films laid on top of a flat screen cannot detect hovering or in-the-air gestures. Pure electro-magnetic pick-up systems behind a flat screen cannot detect finger touch or finger gestures, only electro-magnetic pen operation is possible. However, some types of flat display technologies, in particular OLED displays, can be transparent, thus camera based technologies can be used for gesture control through the screen. If dual-mode input systems including hovering and gestures continue to become more and more important and standardized for providing an efficient and natural user interface, optically based input systems will likely be preferred also for flat interactive screens instead of capacitive or resistive films or electro-magnetic based solutions. Therefore, the preferred input device technology should be optically based and should be suitable to adapt to both conventional flat screens (LCD, plasma, LED) and transparent flat screens like the OLED and rear-projection screens.

Input devices should not be susceptible to light sources as daylight, room illumination, the light from the projector or display screen and so forth. Furthermore, input devices should not be susceptible to near infra-red radiation from sunlight, artificial light or from remote control units and similar which uses near infrared light emitting diodes for communication.

The input devices should further exhibit a high coordinate update rate and provide low latency for the best user experience.

Input devices should preferably be adaptable to fit into existing infrastructure to, for example, upgrade an existing installed pen based interactive whiteboard model to also allow finger touch and hand gesture control, or to upgrade a meeting or education room equipped already with an installed projector or flat screen, to become interactive by a simple installation of the input device itself.

In some scenarios, input technology can even be usable without interactive feedback on the writing surface itself, for example, by capturing precisely the strokes from the chalk and sponge on a traditional blackboard and recognize hand gestures for the control of the computer; or by capturing normal use of pen and paper (including cross-outs) and simple gestures for control of the computer; or by capturing the user's information by filling in of a paper form or questionnaire including his/her signature, while the result is stored in a computer and the input or some interpretation of the input is shown by its normal computer screen or by a connected display or a projector for the reference of the user and the audience. This means that the input device should be possible to use stand-alone or separated from costly display technology in cases where this type of infrastructure is not available or needed.

In the same way that interactive whiteboards are replacing the traditional chalk and blackboard in education, novel interaction spaces are emerging in other arenas. Multi-user interactive vertical and horizontal surfaces are introduced in collaborative rooms and control rooms, museums and exhibitions.

Interactive spaces including interactive guest tables are established in the bars, casinos, cafés and shops, to make it possible for the guests to select from a menu, order and pay, as well as getting entertainment by, for example, playing computer games, browsing the Internet or reading the news. Interactive spaces will be utilized within digital signage using flat displays or projector screens with digital content which can be altered dynamically, not only in a predetermined sequence from the content provider, but changed due to user input from touch and gesture control thus making signage even more flexible, informative and user friendly. Input devices for touch and gesture control for use in interactive signage should work well through vandal-proof thick windows and work well on all kinds of surfaces and flat screens with simple installation, to be suitable to install and use in indoor and outdoor public and commercial areas.

### SUMMARY OF THE INVENTION

The present invention relates to an apparatus, a system and a method for an input device in man-machine communication, for the tracking of an object's position within a coordinate plane; for the detecting of hovering and/or touch conditions within a volume located at the coordinate plane within a given height range; and/or for the recognition of the object's posture, that has
a camera for capturing an image using visual light and/or near infrared light,
a mirror arrangement disposed at the coordinate plane, and a computational unit
   where the camera's field-of-view is including both the coordinate plane and the volume above it and the mirror arrangement, where the mirror arrangement is comprising at least one off-axis concave substantially parabolic element with its axis parallel to the coordinate plane and its focal point at the camera's entrance pupil to provide a constant magnification of the volume's height dimension along its axis, such that the object's coordinates, and/or its hovering and/or touch condition and/or the posture characteristics can be calculated based on a single image by the computational unit, and/or the object's movement and/or the object's gestures can be calculated based on a sequence of images by the computational unit.

The camera comprises a CCD or a CMOS imaging chip or similar, and a lens or similar with a field-of-view large enough to include the coordinate plane, the volume and the mirror arrangement, and with a sufficient optical imaging quality for the actual wavelength ranges adapted to the actual imaging chip resolution.

The present invention has at least one mirror arrangement comprises one or more off-axis substantially parabolic elements distributed at the surface outside the periphery of the coordinate plane. Each such off-axis substantially parabolic element has its focus point in the cameras entrance pupil and its axis parallel to the surface. The property of each off-axis substantially parabolic element is to collimate a set of parallel light rays, parallel to the surface, emanating from the object when the object is inside or partly inside the volume. This property ensures that the measurement of actual height, namely the distance between the object relative to the surface, has constant magnification/scaling for this element, and can easily be determined by locally analyzing the image area which covers this mirror element. The mirror arrangement(s) must further be adapted to ensure that the different sets of parallel light rays from each parabolic element altogether are covering the whole volume over the coordinate plane with no dead spots, such that there will always be at least one mirror element which is covering the object when the object is inside the volume and which is observable from the camera's viewpoint with sufficient number of pixels such that the computational unit can determine the object's actual height, and thus can determine the object's touch condition and/or hovering condition. The camera may also be equipped with some standard or adapted bi-focal lens or similar to magnify the mirror arrangement on the expense of its surroundings, thus increasing the resolution of the imaging of the mirror arrangement in the camera sensor pixel array to a sufficient resolution level for the precise height determination.

While the off-axis substantially parabolic mirror element(s) are distributed at the surface of the coordinate plane adapted to pick up the objects height above the plane, there may be placed additional curved or flat mirror elements further outside the off-axis substantially parabolic mirror elements for providing spatial information of the scene when these latter mirrors are observed from the camera's viewpoint.

There will be additional restrictions for the placement and orientation of the different off-axis substantially parabolic mirror elements in the case where there are obstacles for the direct line-of-sight between the camera's entrance pupil and the surface, for example, due to the mechanical shape of the projector, the size of the wall mount and so forth. In a preferred embodiment, the set of possible placement regions of the off-axis substantially parabolic elements outside these obstacles are registered, and then the placement of each element is selected from this set and assigned an axis direction along the surface in order to distribute the ray beams sufficiently evenly over the coordinate plane without dead spots or shading, while the resulting shape of the mirror arrangement(s) should be smooth and/or well adapted to, for example, the wall mount mechanics and/or projector shape regarding easy manufacturing, easy mounting and good aesthetic appearance.

In preferred embodiments the mirror arrangement is a set of off-axis substantially parabolic elements distributed in a semi-circle around the wall or table mount of the input device. The smaller the radius of this semi-circle is, the more wide angle the resulting optics will be, making the image of the object's width to be more dependent upon the distance between the object and the mirror surface. If this radius is too small, it will be difficult to measure the height of the object at large distances from the mirror since the image in the width direction is diminished too much although the height dimension has constant magnification scaling, irrespective of the object to mirror distance. A proper choice for the radius can be found for the given image and lens resolution, the mirror surface quality and the sensor light budget, as well as the mounting and coordinate plane geometries.

In an alternative preferred embodiment the off-axis substantially parabolic mirror elements are arranged in at least one straight moulding along at least one of the peripheral edges of the coordinate plane. This is a beneficial placement to ensure good observability and distribution of the optical rays emanating from the object, it can be easy to manufacture and mount, and may result in a good aesthetic appearance.

In some alternative embodiments the mirror arrangement can be shaped as a mosaic of small off-axis substantially parabolic segments, each arranged to collect parallel optical rays emanating from the object in different positions and heights, but where the structuring of the direction, placement and height of the segments are optimized to cover the volume over the coordinate plane in the most efficient way for a space limited or shape restricted mirror arrangement, or to find the most efficient mirror arrangement shape for a given minimum object size detection coverage. By utilizing mosaics structures it is possible to find arrangements which give optimal observation, less shading and a good mirror-to-pixel mapping, on the expense of more design optimization effort and image decoding complexity.

The mirror arrangement may be fabricated directly in metal by different fabrication technologies like milling, turning, stamping, 3D laser engraving, grinding and/or EDM. However, to make it suitable for high volume and low cost production, plastics material injection molding and metal coating deposited on plastic can preferably be used, and will also reduce the weight of the mirror arrangement. For higher quality and precision surfaces, metalized glass substrates of different kinds may be used. For lower volumes and lower quality mirrors, thermoforming and vacuum forming of mirror-like metalized plastics material films glued to a base can be a feasible when the radius of curvature is large. Stamping and forming of pre-polished sheet metal may also be used to make the mirrors with a quality which is sufficient for some preferred embodiments of the present invention.

The mirror arrangement may also be fabricated by utilizing total internal reflection in materials such as plastics material or glass.

The mirror arrangement may also be fabricated by utilizing total internal reflection in plastics or glass materials in combination with metal coating for protecting and extending the mirror function (for angles less than the critical angle for which total internal reflection occurs).

In some preferred embodiments the total internal reflection based mirror can be made by Fresnel-like segments. The mirror arrangement may also in some preferred embodiments be fabricated by a combination of a flat mirror segments in given angles and a plastics material lens or plastics material Fresnel lens for providing the required resulting curvature for the off-axis substantially parabolic function.

In some preferred embodiments the off-axis substantially parabolic function can be realized by a lens or Fresnel lens, like those fabricated for solar energy application,

In some preferred embodiments, the mirror arrangement(s) can be covered by a layer of plastic and/or special coating which selectively stops or pass light within given wavelength ranges. Then the moulding or casing can appear to be homogeneous with, for example, a constant dark brown color when observed by the user and the audience in visual light, while the mirror behind the coating is fully functional in the near infrared light within given wavelength ranges from the imaging camera.

In some embodiments the ambient light and/or the light from the display (i.e. light from the projector or from the flat screen, respectively) can be used as to illuminate the object.

In some preferred embodiments an illuminator arrangement in visual and/or near infrared light is included for illumination of the object directly and/or indirectly by the mirror arrangement.

In some preferred embodiments the illuminator arrangements may be controlled by on/off control switch, to turn the illumination on and off selectively for different images.

In some preferred embodiments the illumination source arrangement in the illumination arrangement is flashing within the active exposure period of the camera in order to freeze the motions related to moving objects.

In some preferred embodiments the illuminator arrangement is located in the proximity of the camera's entrance pupil, namely the close to the focal point of the parabolic elements, to illuminate the object through the mirror arrangement, thus spreading the light in the volume located at the coordinate plane within a given height and with rays chiefly in parallel with the plane.

In some preferred embodiments an illuminator arrangement is located in the proximity of the camera's entrance pupil to illuminate the object directly.

In some preferred embodiments there is a common illuminator arrangement for illuminating the object through the mirror arrangement and for illuminating the object directly.

In some embodiments there are separate illumination arrangements for illuminating the object through the mirror arrangement and for illuminating the object directly.

In some embodiments there are separate mirror elements arrangements for the illumination and observation, such that the mirrors in the arrangement for the observation the object's height over the coordinate plane are less exposed to the illumination arrangement itself, thus reducing unwanted reflections of the optical interfaces and by that increasing the signal-to-noise ratio of the measurements.

In some embodiments the on/off-control of the illumination arrangement for illuminating the object through the mirror and the on/off-control of the illumination arrangement for illuminating the object directly are separated, such that the object illumination from the illumination arrangements may selectively be switched on and off for the different images, to provide better detection of the object, for example, to provide contours around the object by sideway illumination.

In some embodiments the illumination arrangements also comprise visual light, for example, multicolor light-emitting diodes with on/off-control, such that the object, for example, a finger can be illuminated with a colored light, for example, green through the mirror arrangement, thus signaling to the presenter that, for example, the selected ink color is green. In the same way a blinking red, can be signaled to the presenter on his finger as a kind of alarm, without being observable by the audience etc.

In some preferred embodiments the camera comprises an optical filter to block out unwanted light, namely the light from the flat display or the projector screen and/or ambient light, while allow light with the same wavelength range as the illumination pass through.

In some preferred embodiments the camera comprises one or more selectable optical filters which selectively can block out or transmit light of different wavelength ranges, and thus, for example, for some images allow light with the same wavelength range as the illumination to pass through, while for other images, for example, allow only the visual light to pass through to then be able to capture the images from the projector or flat screen.

In some preferred embodiments the present invention may be combined with the inventions WO2001NO00369 I U.S. Pat. No. 7,083,100B2 and/or WO2006135241A1/US2009040195A1/US2009040195A1 with objects which are equipped with patterns which may be observable either directly or through the off-axis substantially parabolic elements or the both within a given wavelength range on its surface and/or inside its body and/or projected onto the screen, as a mean for more accurate tracking and/or for the identification of the object and/or for the detection of the state of different user interaction controls, like buttons etc which according to the above mentioned inventions can alter the observable patterns. Also the object's proximity to the surface or the proximity between different internal components of the object may be observed by combining the present invention with the optical proximity detector as described in WO02005050130/U.S. Pat. No. 7,339,684B2. In such preferred embodiments the observation of such patterns and/or proximity information can specifically be done through the present invention's mirror arrangement(s) thus providing constant magnification of this optical information over the complete coordinate plane.

In some further preferred embodiments the above mentioned patterns are made on the object by applying well-known retro-reflective principles at least for a given wavelength range, to utilize that the illumination arrangements are placed close to the camera's entrance pupil, such that the retro-reflective property of the object's will ensure high intensity of the direct observation and/or the observation through the mirror arrangement(s).

In some preferred embodiments of the present invention, a simple computer based calibration procedure can be used for finding an accurate mapping of the coordinate plane to the display coordinates. A common way is to let the calibration procedure be user assisted, by showing crosses in several points on the display, while requiring manual pen or finger touching to find the mapping, namely the transformation matrix.

In some preferred embodiments of the present invention a computer program may put out images on the display with, for example, patterns used for identification and tracking of objects in WO02001NO00369/U.S. Pat. No. 7,083,100B2 and/or WO2006135241A1/US2009040195A1, which may be automatically recognized by the camera to find the transformation matrix to map the coordinate plane to display coordinates. Since the present invention is imaging two different views of an object located in the volume over the coordinate plane, some preferred embodiments of the present invention may include a calibration and control program for also the height dimension, i.e. to control and/or adjusting the thresholds correctly for precise touch and hovering by include a test object which can be observed directly and through the mirrors, respectively. Semi-transparent three-dimensional pattern objects may be illuminated by the display as a part of this calibration procedure. As an illustrating example a semi-transparent cylindrical test object with, for example, some opaque bands along its surface and/or opaque objects inside its volume, is placed in some locations on the display which are highlighted in circular areas one by one by the calibration program. The display will illuminate the semi-transparent test object when placed over these small circular areas such that it can be seen directly by the camera and seen from aside through the mirror arrangement, according to the present invention. The test object may have opaque and transparent details with are dimensioned to be observable in the camera's two views according to the present invention to identify and distinguish different test object; to calibrate and establishing the mapping from coordinate plane's coordinates to the display coordinates; and/or to calibrate or control the height measuring, including the determination and/or of thresholds for touch and hovering conditions for a given installation.

In some preferred embodiments the mirror arrangement and/or the projector mount and/or screen mounts and/or the writing surface may have optical patterns for accurate object positioning in the scene, as described in WO2001NO00369/U.S. Pat. No. 7,083,100B2. This may simplify the mounting and calibration procedure substantially, and the calibration can be done internally by the computational unit of the input device, without manual calibration steps or external computer programs.

It is the purpose of the present invention to provide positional information in X and Y direction, as well as information of touch and hover (Z direction, representing user action information) from the user in a man-machine interface, which is typically, but not necessarily, also including a cooperative display.

It is further the purpose of the present invention to be used for advanced multi-touch interaction which is utilized in human interface devices for computers and other electronic equipment. The fine details in the user's interaction including accurate touch control, hand posture and user gestures, can be captured by the combination of direct observation and observation through the off-axis substantially parabolic mirror arrangement. By using flashing illumination directly or through the mirror arrangement, all movements can be frozen to avoid smearing of the camera images. In some preferred embodiments of the present invention, the illumination can also be provided with separate optics, thus removing reflections involved when illuminating and observing are done concurrently through the same optics thus enhancing the signal-to-noise ratio.

In some further embodiments of the present invention near infrared light illumination sources are used. Furthermore the camera can have an optical filter which block out visual light and so forth, and allow only near infrared light to pass. In such embodiments the invention will be less susceptible to other light sources as daylight, room illumination, the light from projector, display light and so forth.

It is an advantage of the present invention that the magnification of the interaction objects is constant for all distances for a given mirror segment. This implies simple image processing and a very accurate system over large surfaces. The objective of this invention is to make a very robust and accurate touch and hover detection system.

It is further an advantage of the present invention that it is possible to include it into front and rear projection systems on walls and on tables, and the present invention can be either integrated into new equipment or retrofitted into existing equipment for making such systems interactive.

It is a further advantage that the present invention can be mounted on or integrated into projector wall mounts or screen mounts (LCD, OLED etc.).

In some alternative embodiments of the present invention, for very advanced interaction spaces, the use of bi-focal camera lenses can enhance the resolution by magnification of the image around the mirror arrangement to get even more precise touch and height information. Alternatively, the lens optics may be separated for the direct view and the view through the off-axis substantially parabolic mirror elements, to miniaturize the equipment, reduce cost and simplify installation. This can be achieved by utilizing available low-cost CMOS image sensor technologies which provide full exposure synchronization and streaming of a pair of images from two separate sensors by a interconnected high speed serial link, and then use lens optics best suited for the two separate views, and then executing the same computations on the pair of images by the computational unit. The speed-up scheme described for the present invention will also apply in such dual sensor/lens configuration.

The present invention can utilize low cost CCD or CMOS camera technology and low cost near infrared LEDs and optics which is easy and cheap to manufacture, and available signal processing integrated circuits which is easy to program for the actual application. The present invention is therefore easy to implement in high production volumes.

In some scenarios the present invention can also determine, for example, hand postures as a second interaction object within the camera's field of view but not necessarily within the defined interaction volume, wherein the posture of the at least one first object is determined, such that the posture of the second object may provide additional information in the human interaction with the computer.

The method based on observing the object by the off-axis substantially parabolic mirror arrangement provides explicitly the height Z over the interaction surface, synonymous with hover level information. Merely by executing simple edge detection over the camera pixels representing the different off-axis substantially parabolic mirror elements, it is possible to determine the presence and the height of an interacting object. One may use different image processing methods to detect the actual changes in the image regions of the mirror elements, like for example subtraction of a reference image, find absolute differences in the image, as well as normalization, thresholding (i.e. comparing with one or more threshold values) for finding for example a binary representation which easily can be processed further for finding candidate objects by blob detecting algorithms or template matching techniques. The candidate objects can be located both in the mirror view looking along the interaction surface, and in the direct view, namely the view of the interaction surface itself. The so-called correspondence problem, namely where correspondent image information from two different viewpoints are to be identified, is in general a very complex problem, and is a key problem in stereographical and artificial 3D vision systems. By utilizing the off-axis substantially parabolic mirrors, the height (Z) information is explicit and linearly represented without any perspective distortion as a function of the object's (X,Y) position in the interaction volume. The correspondence problem for the present invention is therefore reduced in complexity compared to a general case, but can be further simplified by the method described below.

The method based on observing the object by the off-axis substantially parabolic mirror arrangement provides, as already discussed, explicitly hover level information. The method also makes it possible to find the interaction objects faster by utilizing a characteristic that the view through the off-axis substantially parabolic mirror element is a look along the interaction volume in a particular direction, meaning that several object positions are mapped to one single mirror element or a group of such elements, and can be observed by the camera having a low number of pixels. For the initial search for where the object are located, image processing of the limited camera pixel area related to the mirror arrangement, will easily find the height of the object and the direction where the object is located. In the aforementioned mirror arrangement where the off-axis substantially parabolic elements are distributed in a semi-circle, then the height (Z) and the azimuth (AZ) angle representing the direction to the object can be directly found, and a trajectory of candidate object positions in the interaction volume can be determined. This trajectory can be transformed to a trajectory in the image sensor array by for example a look-up table, and can then be searched for the presence of the object by for example an edge detecting algorithm run along this trajectory. This method represent an efficient search procedure for finding the object(s) in the image with a high computational speed-up compared to a full two-dimensional search in the image sensor array for the entire interaction surface.

Furthermore a redundancy scheme can be utilized with the present invention to find the position, hovering level and touch of object(s) even when the direct image of the object(s) are occluded in the direct camera view, by utilizing two or more mirrors. The user may occasionally and unintentionally hide the pen, his/her fingers or his/her hand during an interaction session by, for example, his/her other hand or his/her head, when seen from the direct camera view point, while two mirrors along the interaction surface can follow the objects, determine their heights, find their touch and hover condition, and calculate their positions by triangulation of the azimuth angles of the objects as observed in the mirrors with a given base length.

By tracking the relative movements and the accompanying types of postures as can be determined from image to image, such sequences can be interpreted as hand gesture commands, which to some extent are incorporated in user interfaces for computers, mobile devices and embedded systems.

The present invention is providing interaction systems using pen, touch or both (dual-mode systems) suitable for education, collaboration and meetings. Now operating systems and graphical user interfaces are prepared for dual-mode multi-touch and multi-pen input, and they can distinguish between touch, pen and mouse input. By combining interaction objects and pens with optical patterns and other objects, like the fingers and the hand, image recognition and pattern matching can be used to distinguish between these input modes and provide the dual-mode information from diverse interaction objects to the computer as multi-touch, multi-pen and mouse information concurrently to the computer. Several new interaction platforms also allow simple pen or finger gesture control, and/or even hand gesture based interaction.

The invention can be utilized in interactive tablets and whiteboards in classrooms, lecture halls, meeting rooms, video conferencing rooms, and collaboration rooms. The invention can be used together with short-throw or long-throw data projector, or together with a flat screens as LCD display, plasma display, OLED display or rear-projection system, without reducing the picture quality or wearing out the equipment. Technology based on the present invention can easily be adopted to different screens, projectors and display units with low cost and effort.

The present invention is ideal for short-throw typically mounted on the wall, since it can be integrated into or attached alongside the wall projector, or attached to the projector wall mount, to make installation simple and robust.

The present invention can also be utilized in lecture hails, where very long interactive whiteboards and interaction spaces are required to provide touch, pen and gesture control and can also interact with pointing sticks and laser pointers and be tolerant to and adaptable to different display formats.

The present invention can also be utilized together with flat screen technologies to make them interactive, including posture and gesture control. Since the present invention is based on using CMOS image sensors and signal processing, the system can exhibit a high coordinate update rate and provide low latency giving the best user experience.

The interaction systems according to the present invention can very easily be adaptable to fit into existing infrastructure to, for example, upgrade an existing installed pen based interactive whiteboard model to also allow finger touch and hand gesture control, or to upgrade a meeting or education room equipped already with an installed projector or flat screen, to become interactive by a simple installation of the input device itself.

The interaction system according to the present invention can also be used in multi-user interactive vertical and horizontal surfaces in collaborative rooms and control rooms, museums and exhibitions, in interactive guest tables in restaurants and within digital signage in indoor and outdoor public and commercial areas.

The present invention will also provide advanced user multi-touch interaction into education and business marked. The present invention will be suitable for small and medium displays, as well as large and wide school and lecture hall whiteboards.

The present invention can also be used with or without a display in education, for interactive signage, and in museums and exhibitions.

### DESCRIPTION OF THE DRAWINGS

The invention is herein described, by way of examples only, with reference to accompanying drawings, wherein:

FIG. 1 is an illustration of an exemplary configuration according to a preferred embodiment of the present invention, wherein a mirror arrangement of off-axis substantially parabolic elements is organized in a semi-circular manner around a short-throw projector mount;

FIG. 2 is a presentation of a configuration as provided in FIG. 1 in a side view;

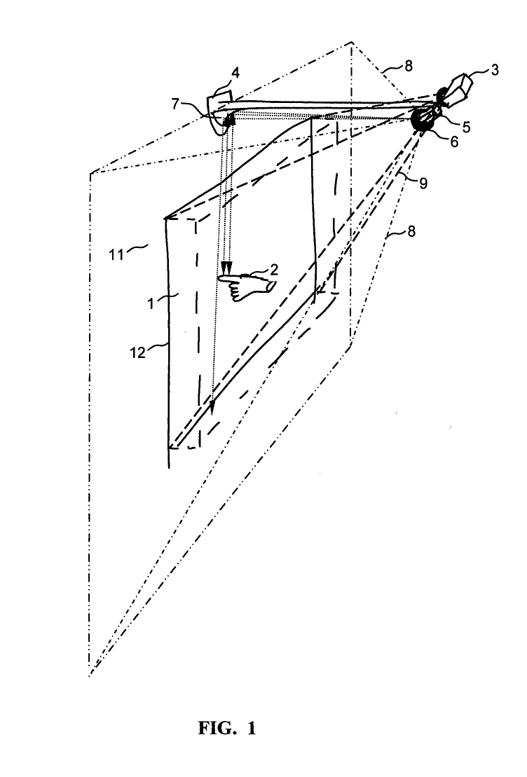

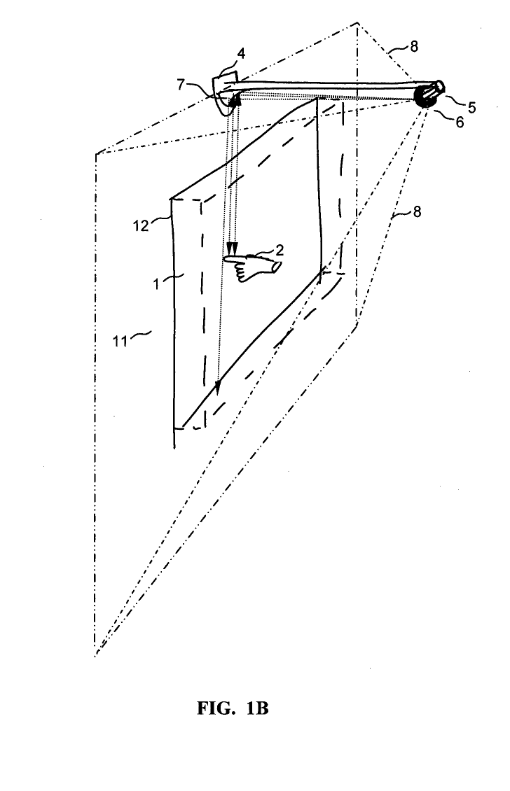

FIG. 1B is an illustration of an exemplary configuration according to a preferred embodiment of the present invention, wherein a mirror arrangement of off-axis substantially parabolic elements is organized in a semi-circular shape over the flat screen;

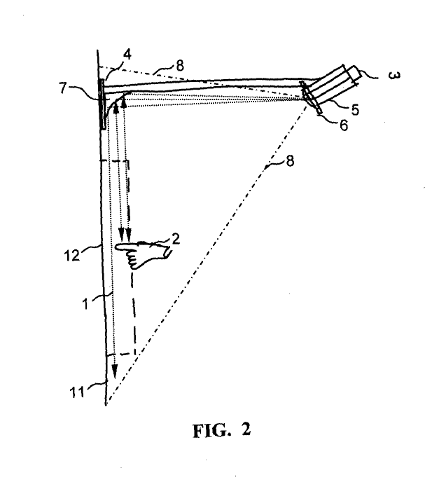

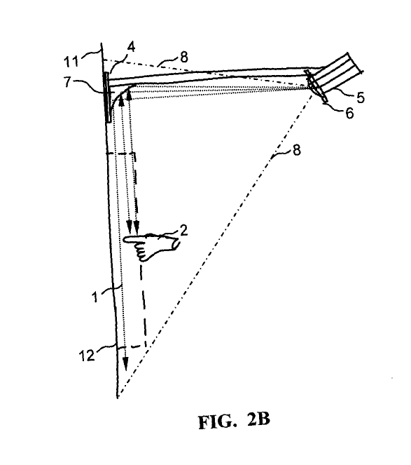

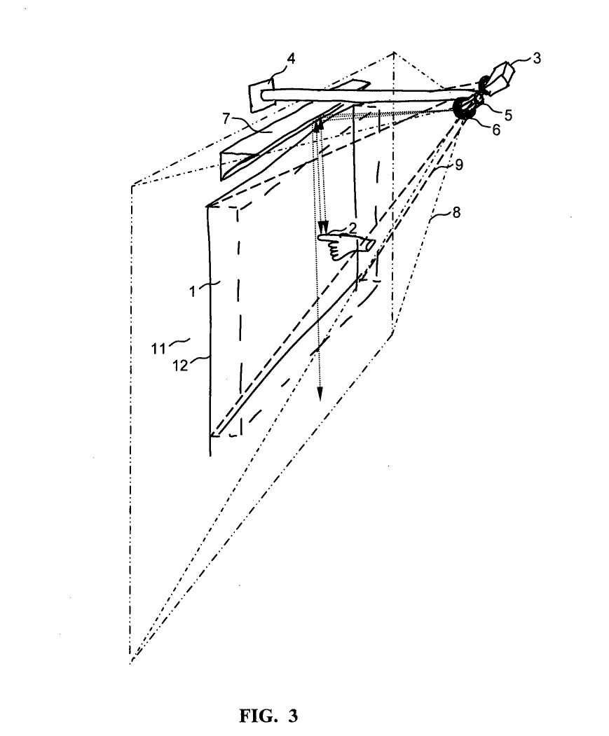

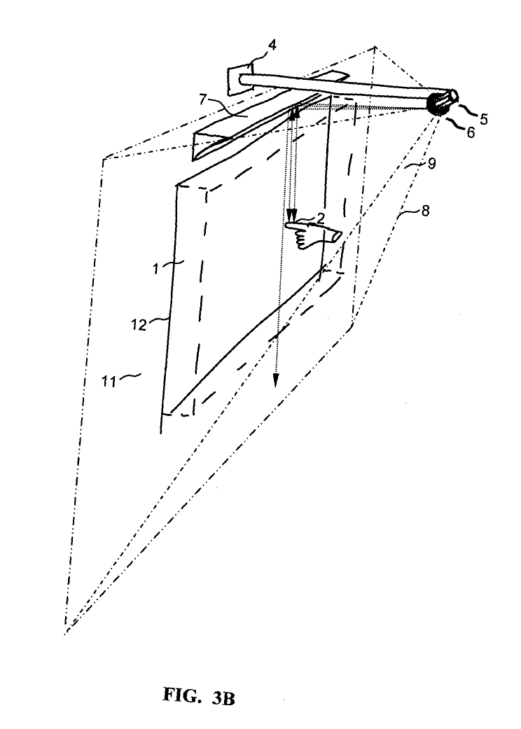

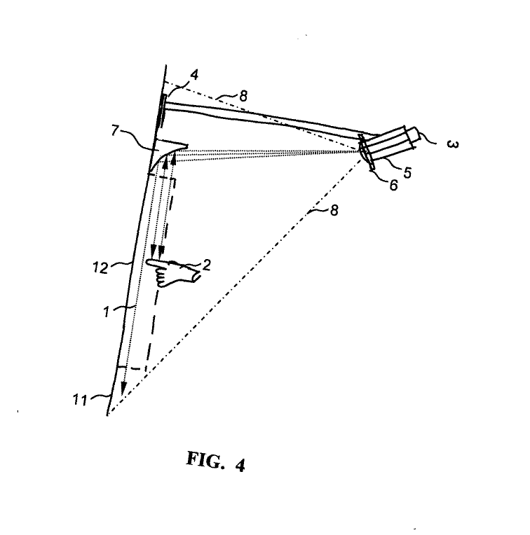

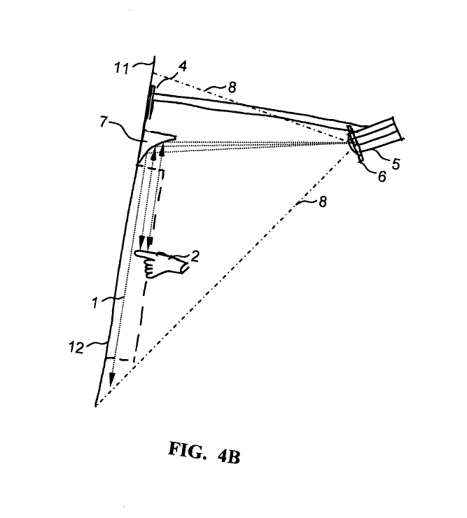

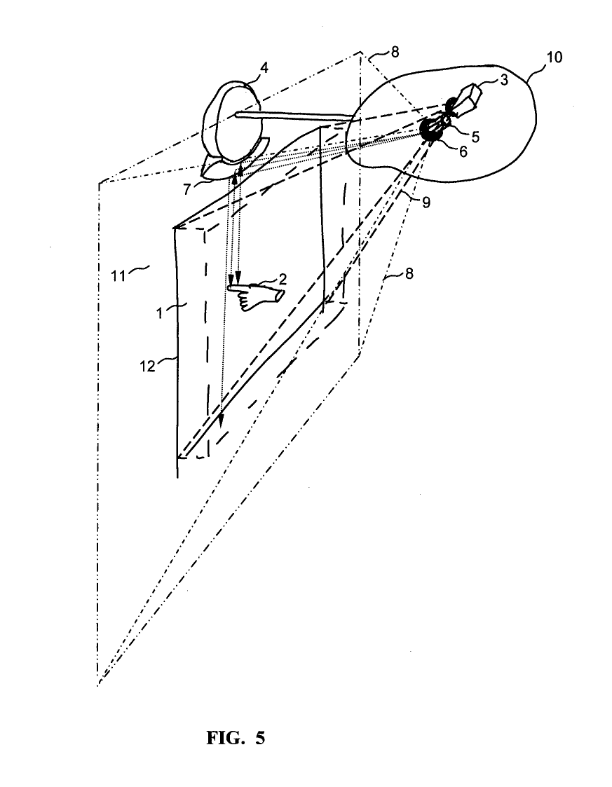

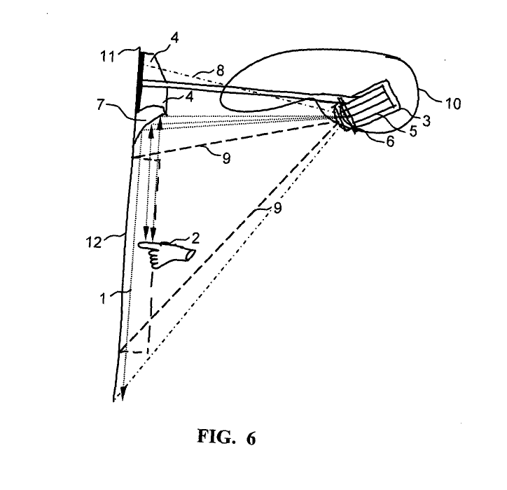

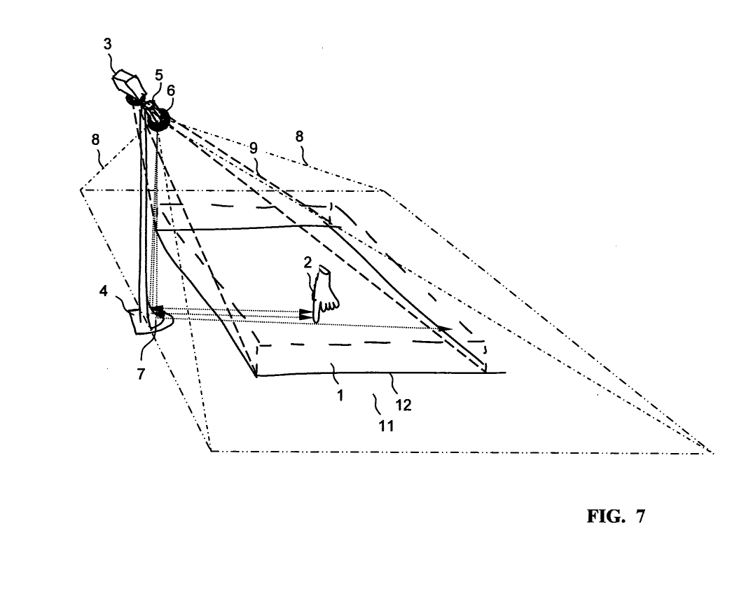

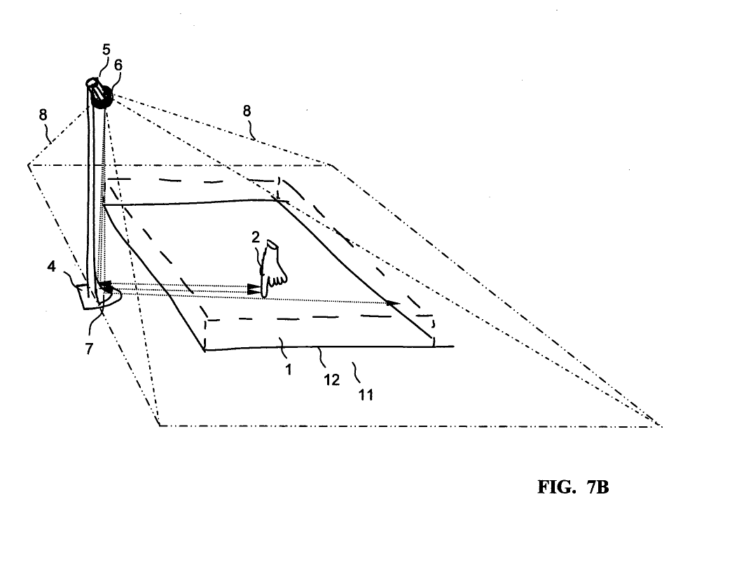

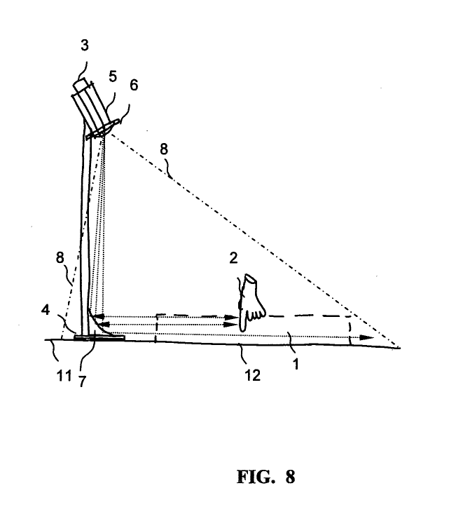

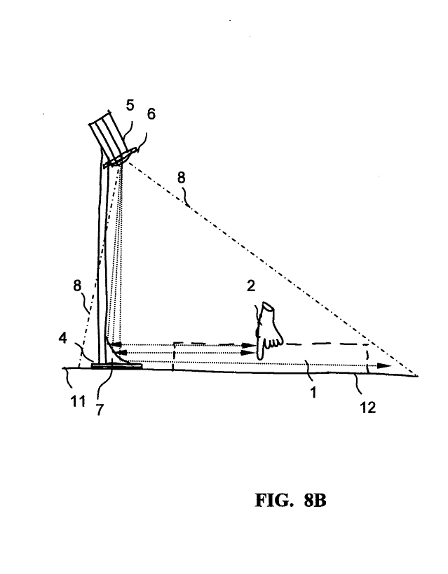

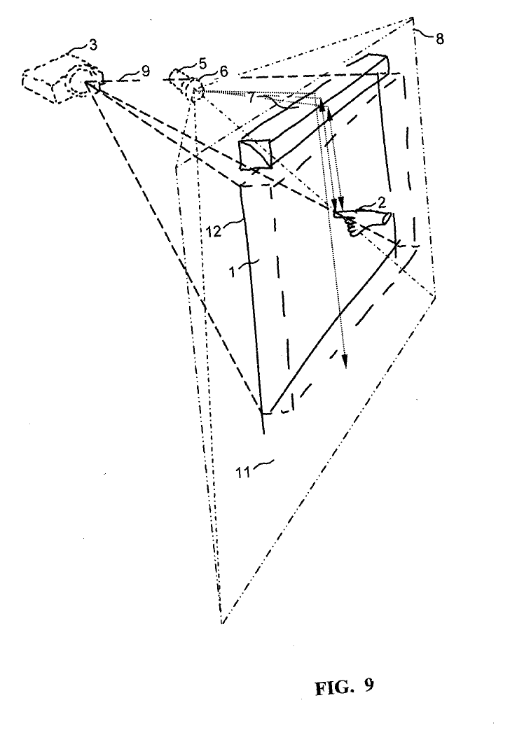

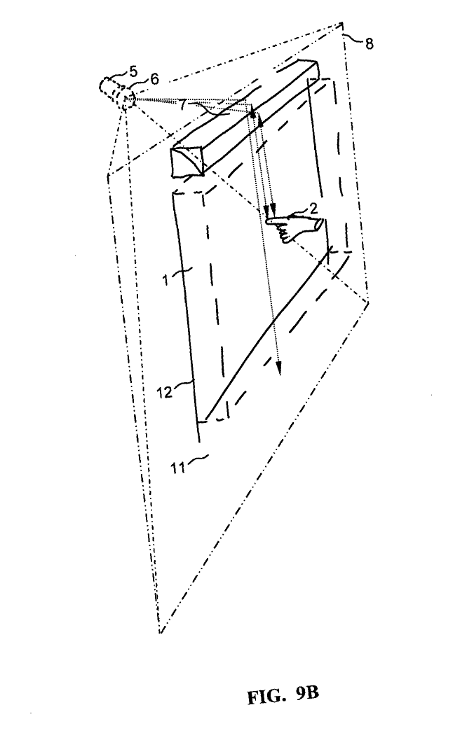

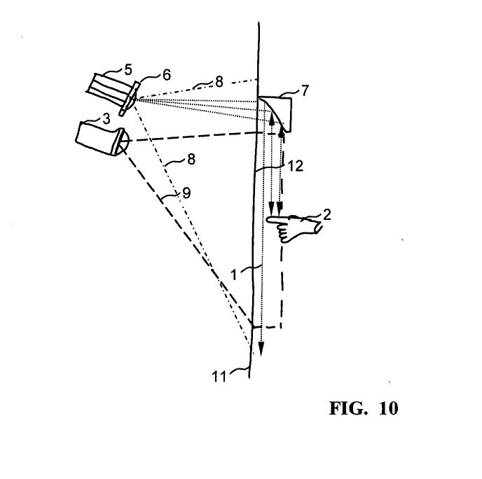

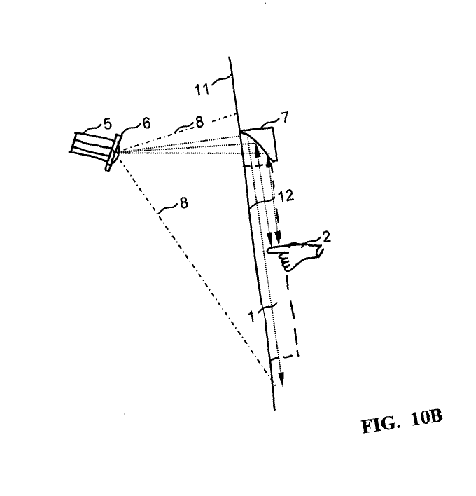

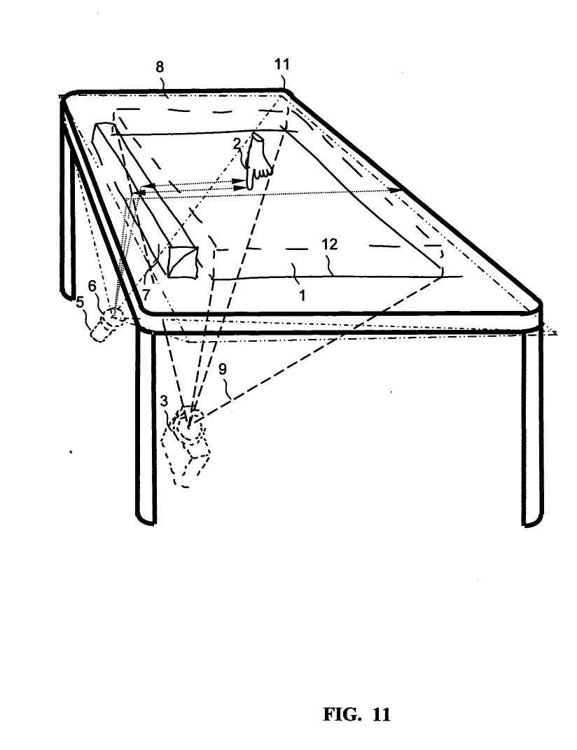

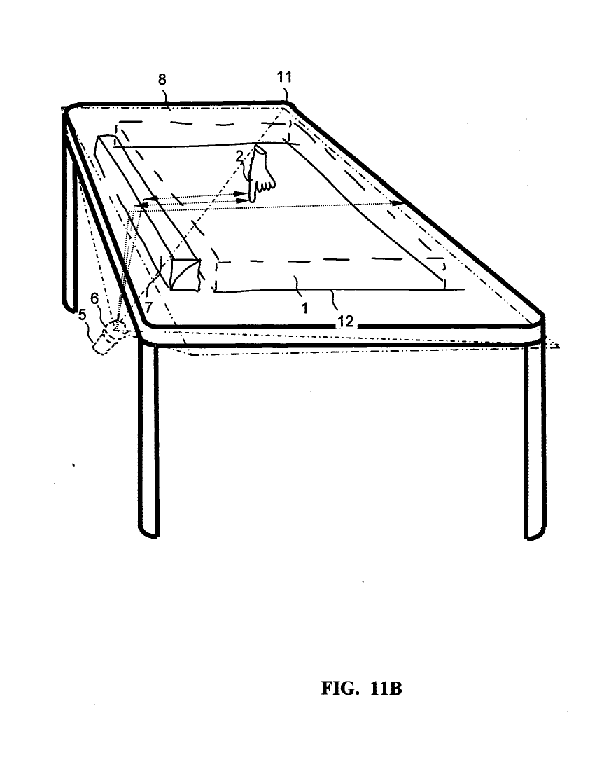

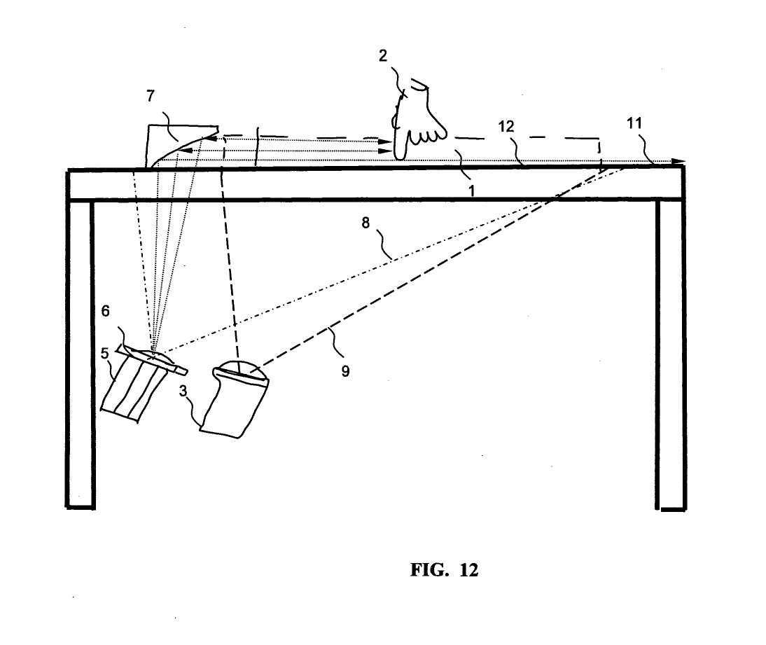

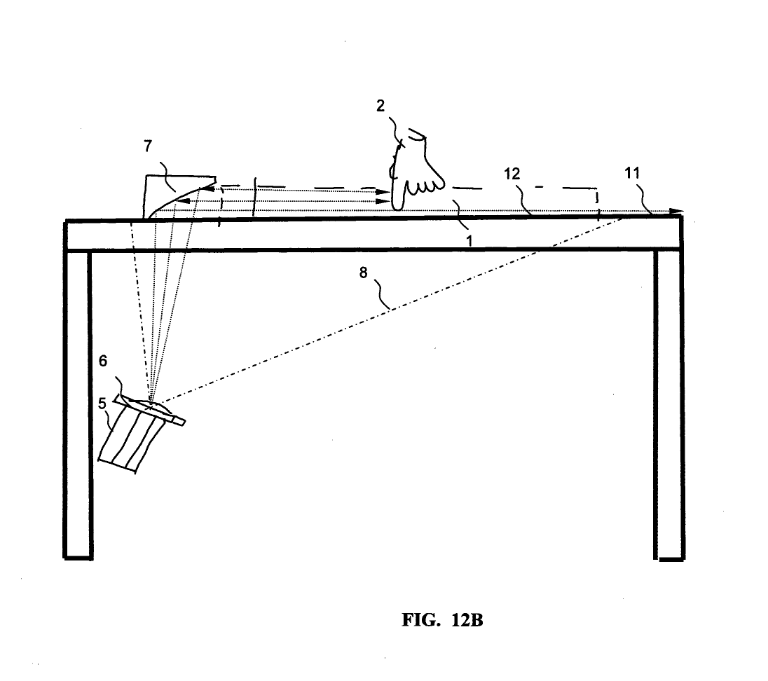

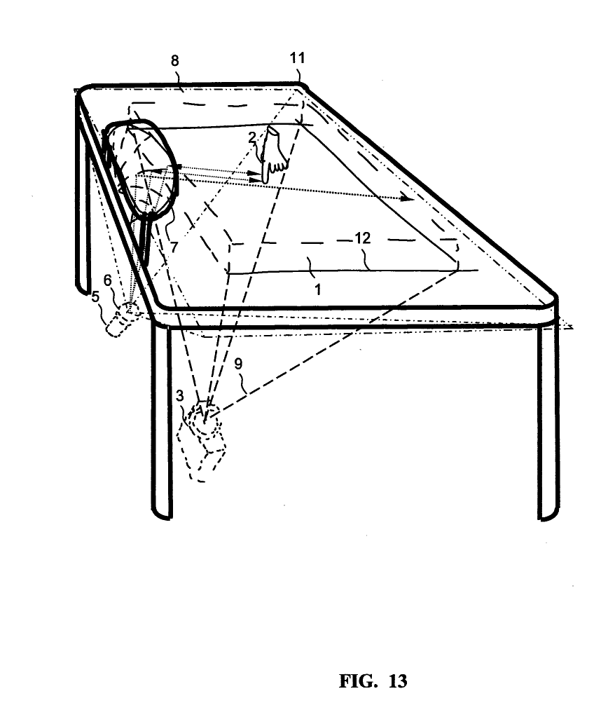

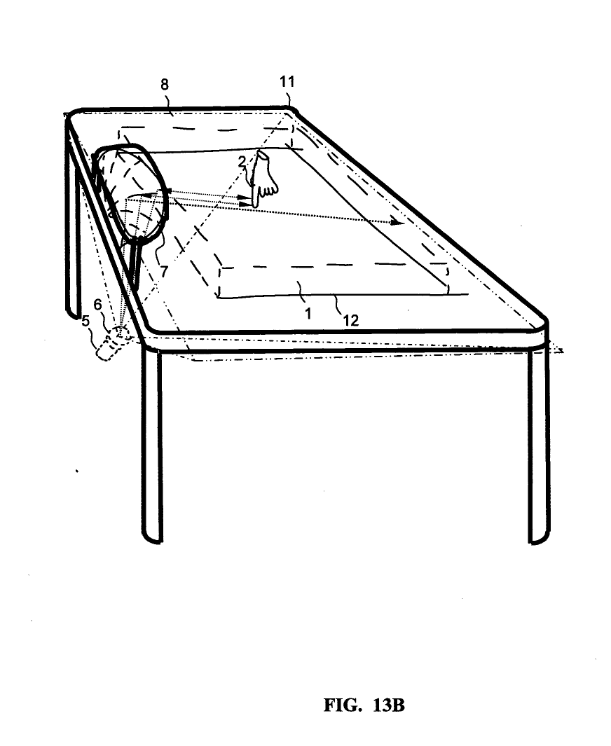

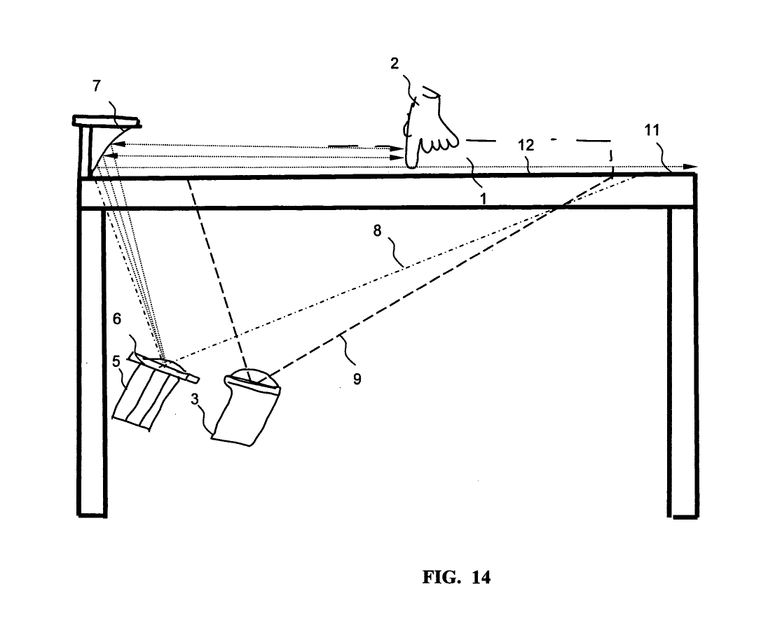

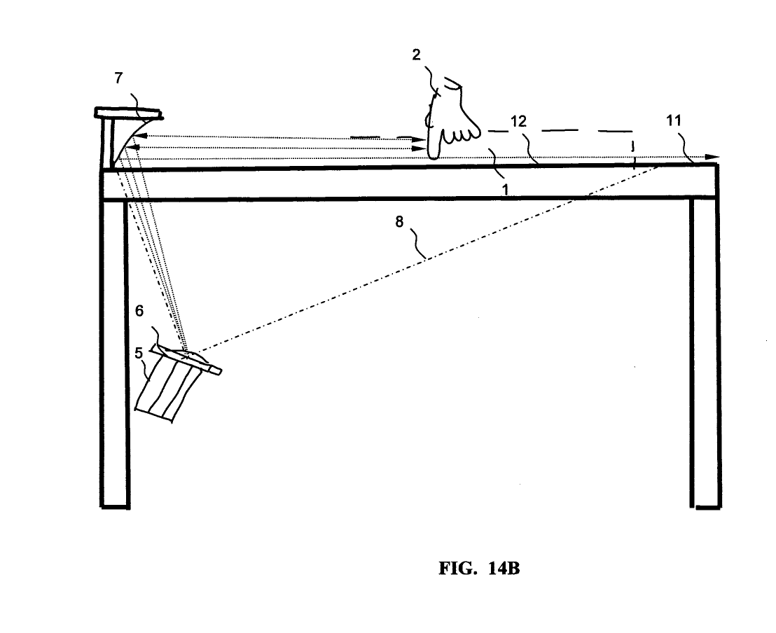

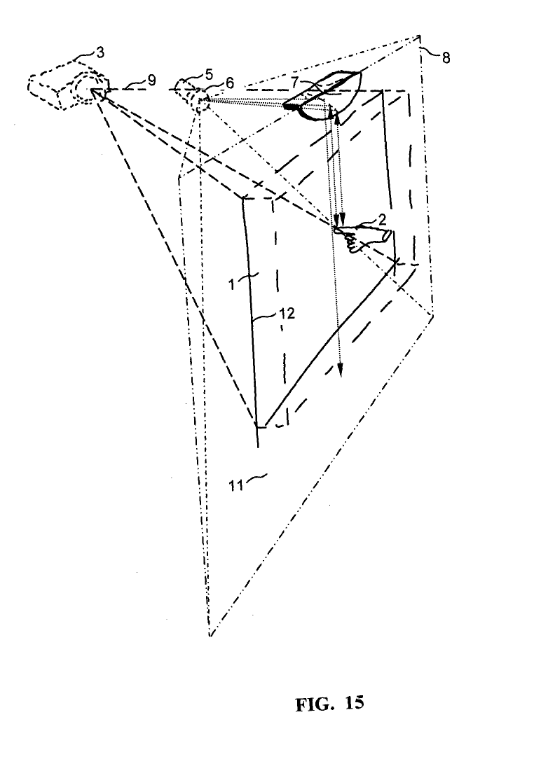

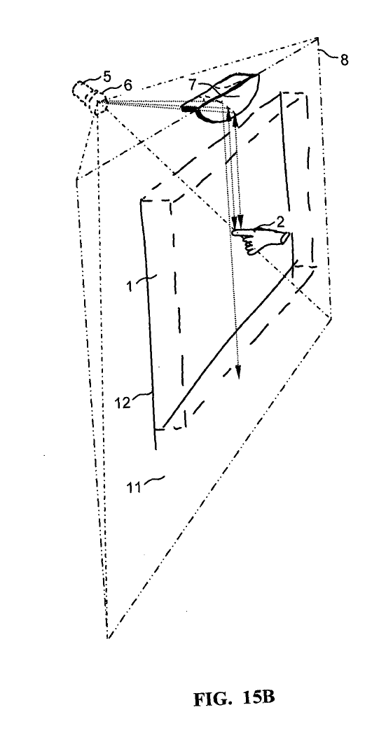

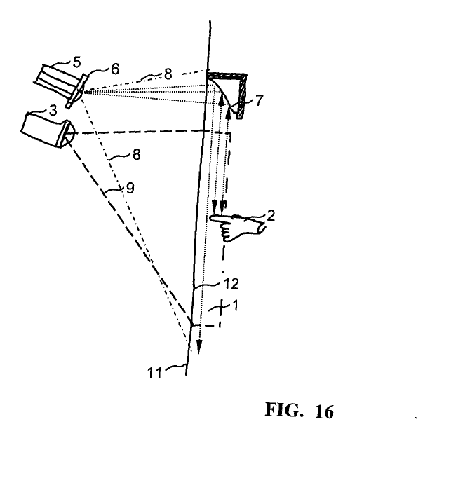

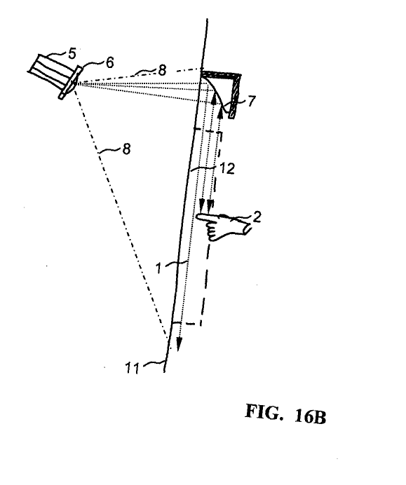

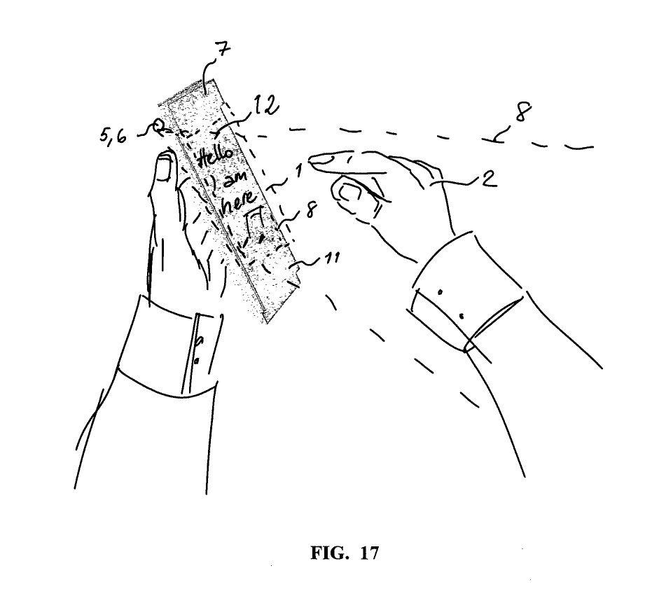

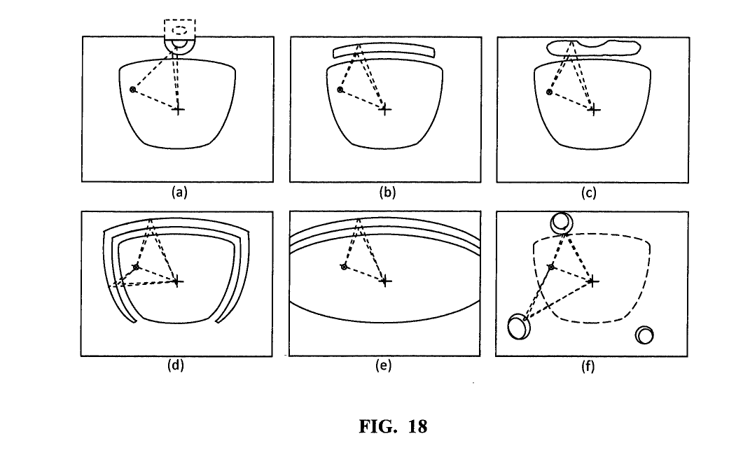

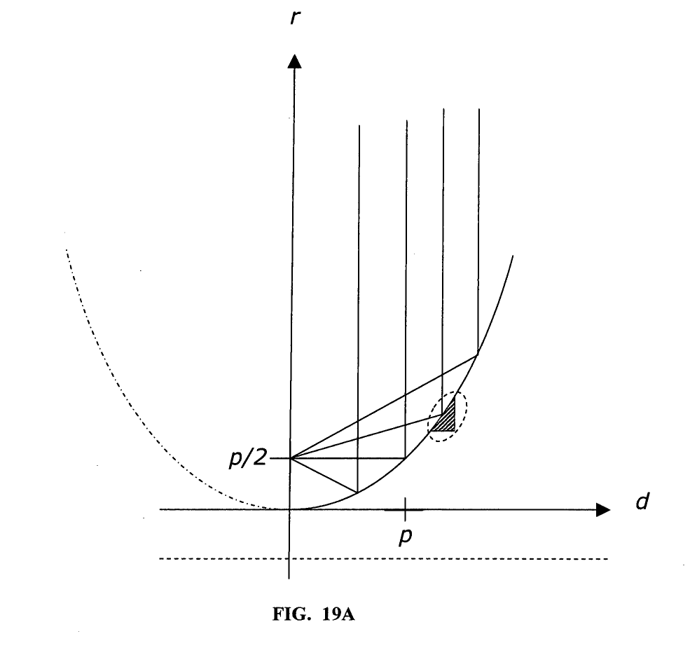

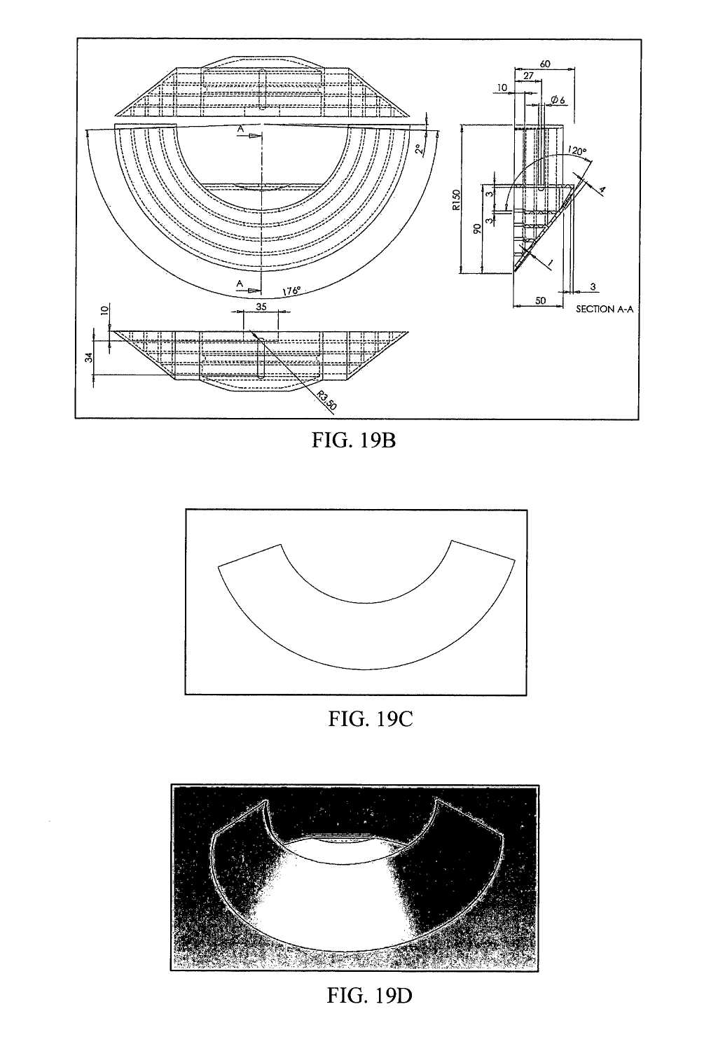

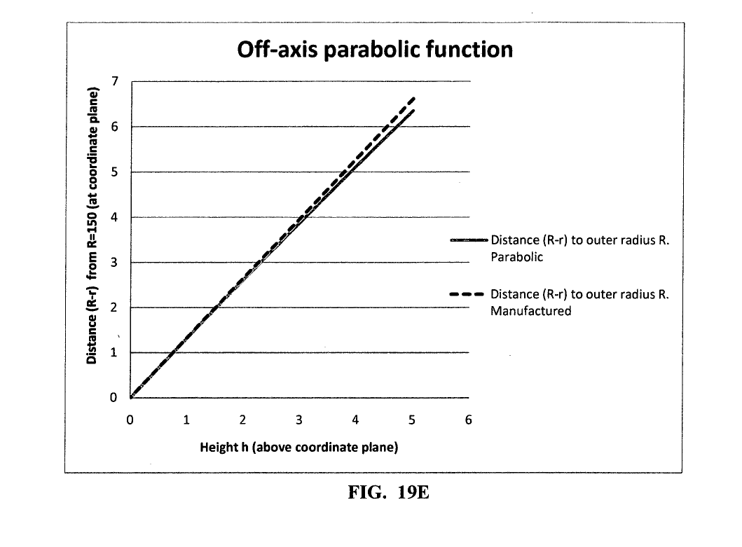

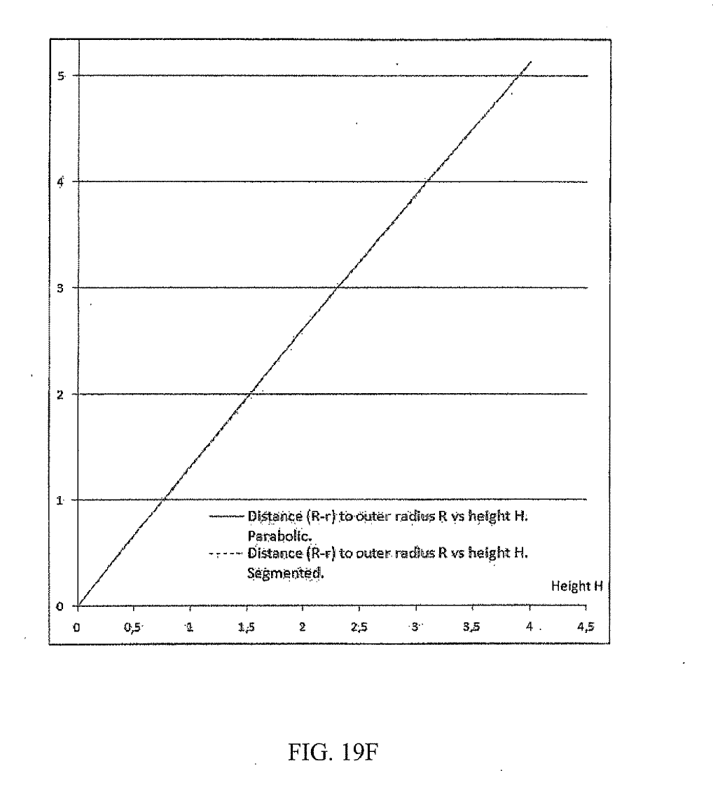

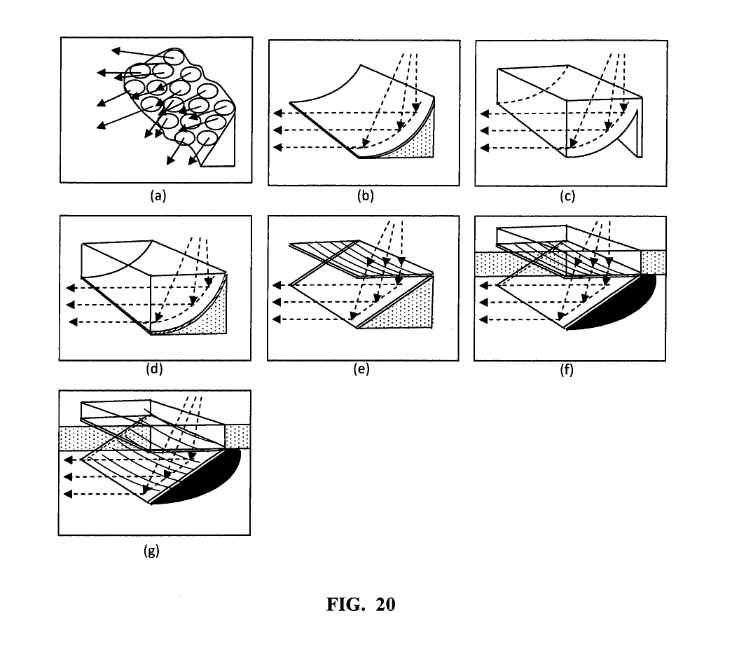

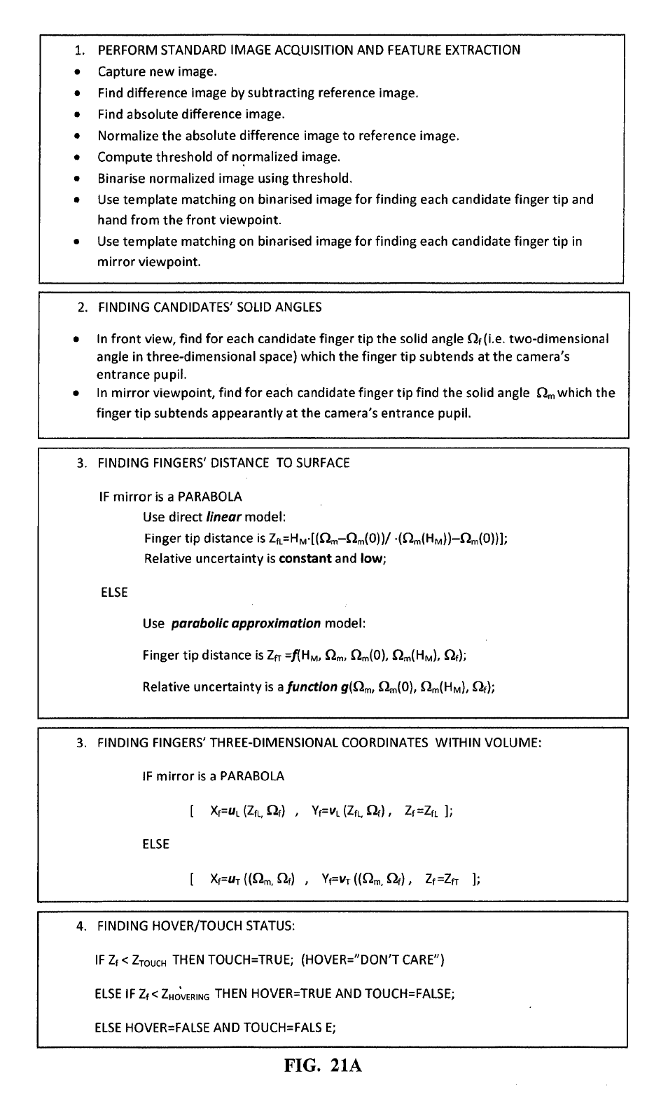

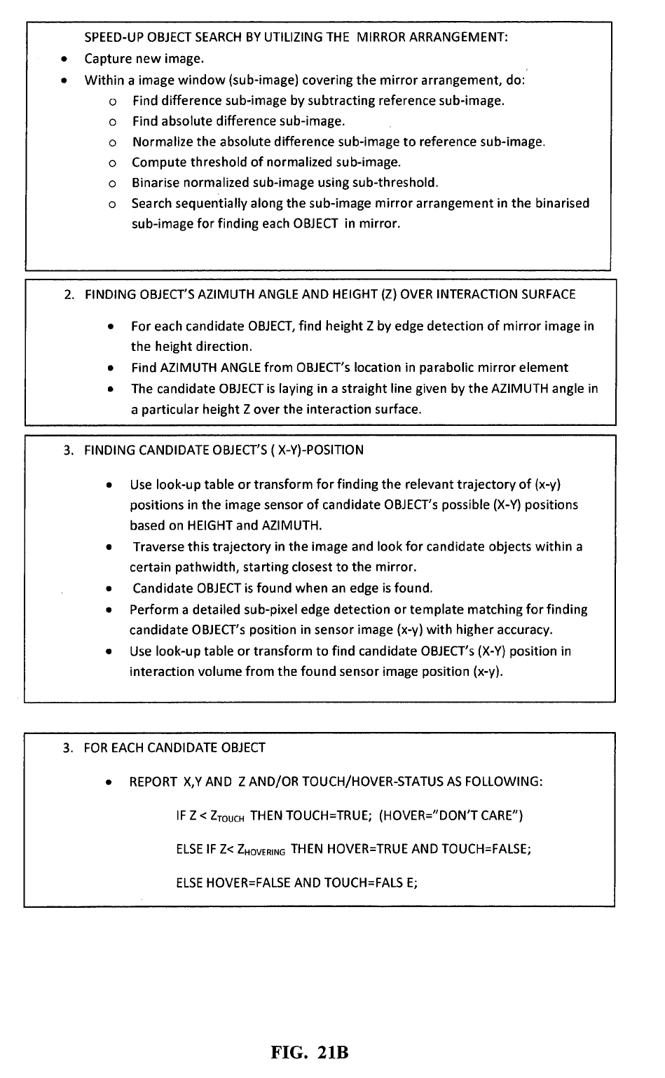

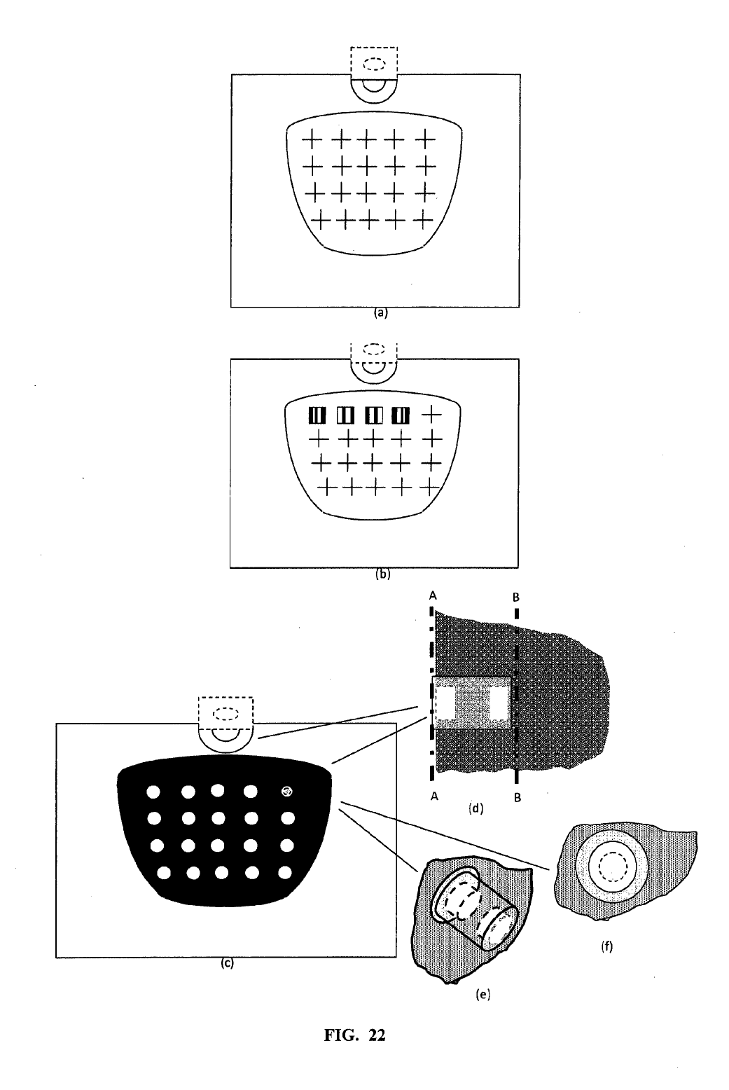

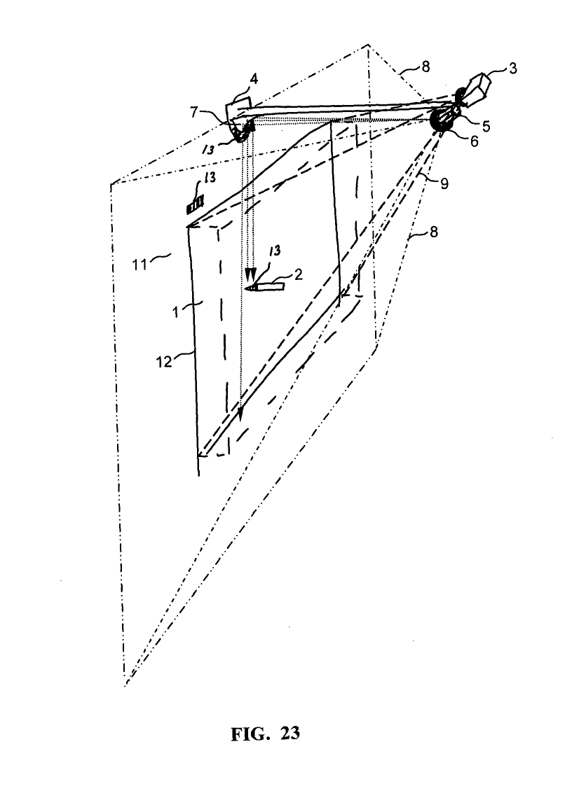

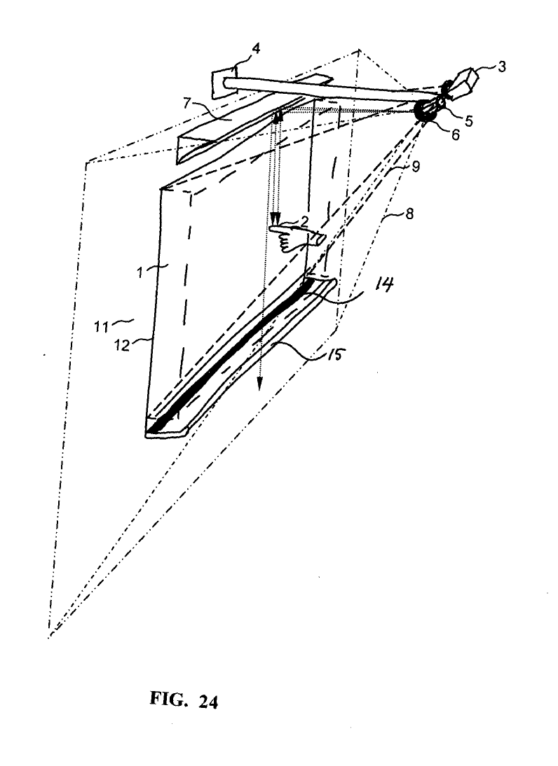

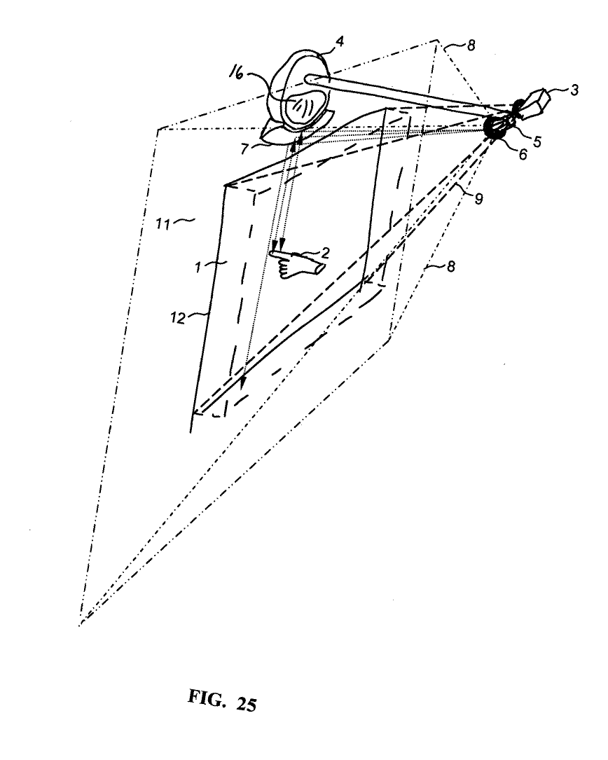

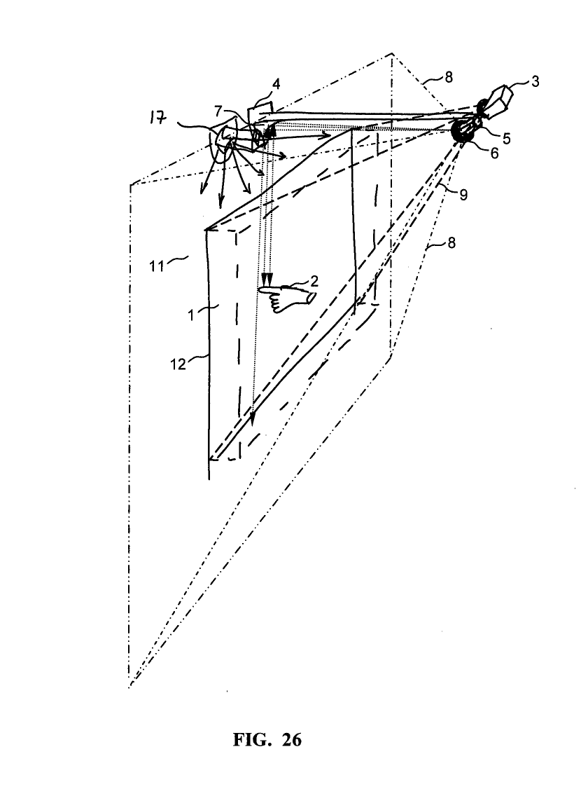

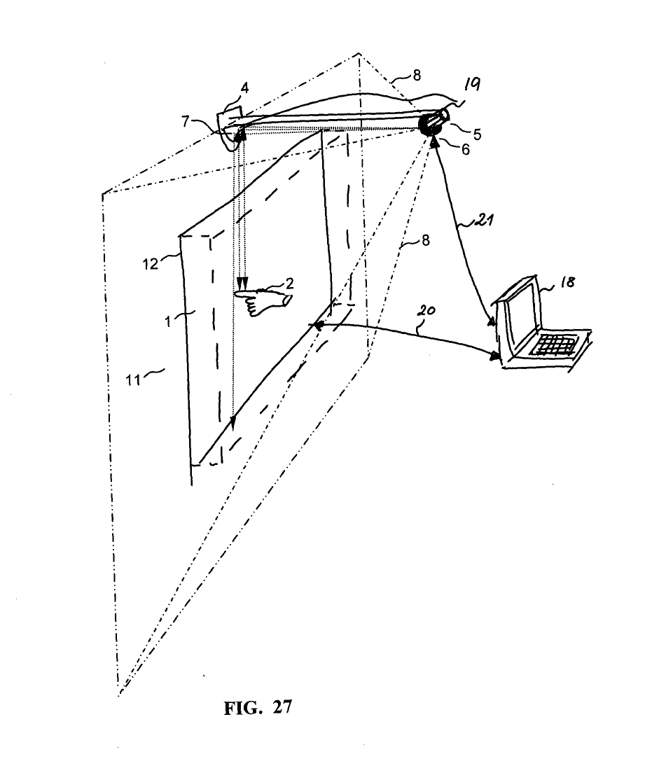

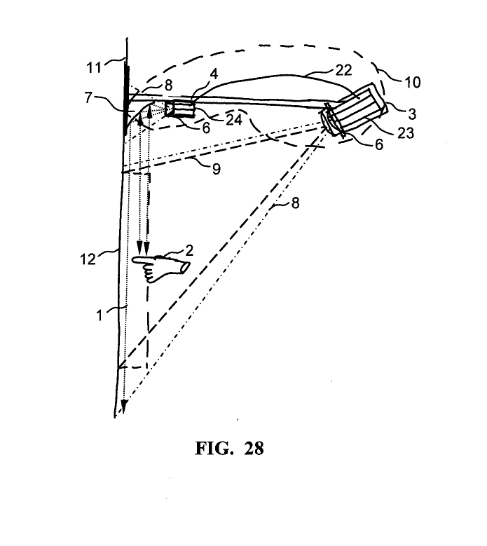

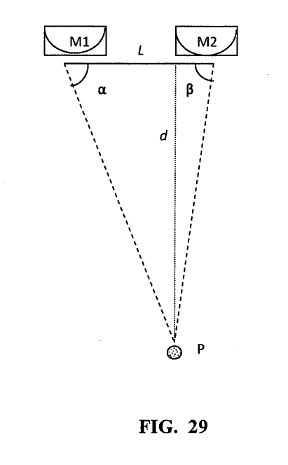

FIG. 2B is an illustration of a configuration as provided in FIG. 1B in a side view;

FIG. 3 is an illustration of an exemplary configuration according to a preferred embodiment of the present invention, wherein a mirror arrangement of off-axis substantially parabolic elements is organized along a straight moulding just above a projector display area;

FIG. 4 is a presentation of a configuration as provided in FIG. 3 in a side view;

FIG. 3B is an illustration of an exemplary configuration according to a preferred embodiment of the present invention, wherein a mirror arrangement of off-axis substantially parabolic elements is organized along a straight moulding just above a flat display area;

FIG. 4B is a presentation of a configuration as provided in FIG. 3B in a side view;

FIG. 5 is an illustration of an exemplary configuration according to a preferred embodiment of the present invention, wherein a mirror arrangement of off-axis substantially parabolic elements is organized to avoid obstacles like, for example, a short-throw projector chassis or a mount, to dispose the mirror elements in areas of direct line-of-sight from a camera disposed outside a display area;

FIG. 6 is a presentation of a configuration as provided in FIG. 5 in a side view;

FIG. 7 is an illustration of an exemplary configuration according to a preferred embodiment of the present invention, wherein a mirror arrangement of off-axis substantially parabolic elements is organized in a semi-circular shape on a table close to a projector and a camera mount;

FIG. 8 is a presentation of a configuration as provided in FIG. 7 in a side view;

FIG. 7B is an illustration of an exemplary configuration according to a preferred embodiment of the present invention, wherein a mirror arrangement of off-axis substantially parabolic elements is organized on a table close to a camera mount and a flat screen;

FIG. 8B is a presentation of a configuration as provided in FIG. 7B in a side view;

FIG. 9 is an illustration of an exemplary configuration according to a preferred embodiment of the present invention, wherein the mirror arrangement of off-axis substantially parabolic elements is organized organized along a straight moulding just above projector display area for a rear-projection system;

FIG. 10 is a presentation of a configuration as provided in FIG. 9 in a side view;

FIG. 9B is an illustration of an exemplary configuration according to a preferred embodiment of the present invention, wherein a mirror arrangement of off-axis substantially parabolic elements is organized along a straight moulding just above a display area for a transparent screen (e.g. OLED) system;

FIG. 10B is a presentation of a configuration as provided in FIG. 9B in a side view;

FIG. 11 is an illustration of an exemplary configuration according to a preferred embodiment of the present invention, wherein a mirror arrangement of off-axis substantially parabolic elements is organized along a straight moulding just above a top side of a projector display area for a rear-projection system mounted in a table;

FIG. 12 is a presentation of a configuration as provided in FIG. 11 in a side view;

FIG. 11B is an illustration of an exemplary configuration according to a preferred embodiment of the present invention, where a mirror arrangement of off-axis substantially parabolic elements is organized along a straight moulding just above a display area for a transparent screen (e.g. OLED) mounted in a table;

FIG. 12B is a presentation of a configuration as provided in FIG. 11B in a side view;

FIG. 13 is illustration of an exemplary configuration according to a preferred embodiment of the present invention, wherein a mirror arrangement of off-axis substantially parabolic elements is organized along a circular shape, for example, above a top side of a projector display area for a rear-projection system mounted in a table, or organized in elements in areas of direct line-of-sight from a camera to avoid obstacles but outside the display area;

FIG. 14 is a presentation of a configuration as provided in FIG. 13 in a side view;

FIG. 13B is an illustration of an exemplary configuration according to a preferred embodiment of the present invention, wherein a mirror arrangement of off-axis substantially parabolic elements is organized along a circular shape, for example, above a top side of a transparent display (e.g. OLED) screen mounted in a table, or organized in elements in areas of direct line-of-sight from a camera to avoid obstacles but outside the display area.

FIG. 14B is a presentation of a configuration as provided in FIG. 13B in a side view;

FIG. 15 is an illustration of an exemplary configuration according to a preferred embodiment of the present invention, wherein a mirror arrangement of off-axis substantially parabolic elements is organized along a circular shape, for example, above a top side of a projector display area for a wall-mounted rear-projection system, or organized in elements in areas of direct line-of-sight from a camera to avoid obstacles but outside the display area;

FIG. 16 is a presentation of a configuration as provided in FIG. 15 in a side view;

FIG. 15B is an illustration of an exemplary configuration according to a preferred embodiment of the present invention, wherein a mirror arrangement of off-axis substantially parabolic elements is organized along a circular shape, for example, above a top side of a transparent display (e.g. OLED) screen mounted on a wall, or organized in elements in areas of direct line-of-sight from a camera to avoid obstacles but outside the display area;

FIG. 16B is a presentation of a configuration as provided in FIG. 15B in a side view;

FIG. 17 is an illustration of an exemplary configuration according to a preferred embodiment of the present invention, wherein a mirror arrangement of off-axis substantially parabolic elements is organized along a straight moulding just above a display area for a transparent screen (e.g. OLED) mounted in a handheld device;

FIG. 18 is an illustration of typical camera images for some exemplary configurations according to preferred embodiments of the present invention, wherein the mirror arrangement of off-axis substantially parabolic elements is organized in various different ways;

FIG. 19A is an illustration of a parabola and an off-axis segment;

FIGS. 19B to 19F are illustrations of exemplary configurations of off-axis concave substantially parabolic elements, and also illustrations of some manufacturing limitations;

FIG. 20 is an illustration of exemplary configurations of mirror elements according to preferred embodiments of the present invention;

FIG. 21A is a flow diagram illustrating an exemplary methodology that facilitates finding fingers' distance to a surface, finding fingers' three dimensional coordinates within a volume, and a touch and hovering status of the fingers;

FIG. 21B is a flow diagram illustrating a speed-up methodology for finding an object;

FIG. 22 is an illustration of exemplary methodologies that facilitate calibration of a camera to a display screen, according to a preferred embodiment of the present invention;

FIG. 23 is an illustration of exemplary configurations of a pen with tracking patterns, a mirror with localization control patterns, and a coordinate plane with localization control patterns;

FIG. 24 is an illustration of exemplary configurations of providing a controlled background for imaging and for measuring by using a small moulding or list along one or more edges of a coordinate plane;

FIG. 25 is an illustration of exemplary configurations of a mirror arrangement of off-axis substantially parabolic elements at a coordinate plane combined with additional curved or flat mirror elements further outside the coordinate plane, for providing spatial information, observed by using a camera;

FIG. 26 is an illustration of exemplary configurations of a mirror arrangement of off-axis substantially parabolic elements at a coordinate plane for an observation of an object's height relative to a coordinate plane, combined with a separate apparatus for illumination;

FIG. 27 is a schematic illustration of a system comprising a display, a cooperating computer and an apparatus according to the present invention;

FIG. 28 is an illustration of an exemplary configuration according to a preferred embodiment of the present invention, wherein a direct view and a mirror view are captured by two cooperating separated image sensors with optics to optimize each view for low manufacturing cost, miniaturization and simple set-up; and

FIG. 29 is a schematic illustration of an exemplary configuration of a mirror arrangement of two sections consisting of off-axis substantially parabolic mirror elements MI and M2 which can be observed by a camera and an object P which is located in an interaction volume.

### DESCRIPTION OF EMBODIMENTS OF THE INVENTION

The present invention pertains to an apparatus, a system and a method for a camera-based computer input device for man-machine interaction. Moreover, the present invention also concerns apparatus for implementing such systems and executing such methods.

Before explaining at least one embodiment of the invention in detail, it is to be understood that the invention is not limited in its application to the details of construction and arrangements of components set forth in the following description or illustrated in the drawings. The invention is capable of being implemented by way of other embodiments or of being practiced or carried out in various ways. Moreover, it is to be understood that phraseology and terminology employed herein are for the purpose of description and should not be regarded as being limiting.

The principles and operation of the interaction input device apparatus, system and method, according to the present invention, may be better understood with reference to the drawings and their accompanying descriptions.

Firstly, a principle of an interaction device and an interaction system will be described. Thereafter, a detailed description of some preferred embodiments will be described together with their detailed system operation principles.

The principle of the interaction apparatus and interaction system is described by referring to an exemplary configuration as illustrated in FIG. 1 and FIG. 2 which schematically depict a hardware configuration of a preferred embodiment of the present invention, as seen in perspective and from side view. The hardware components of this embodiment are a short-throw data projector 3 placed along with a camera 5 and an illuminant 6 on a wall mount 4.

The appearance and the practical implementation of the wall mount 4 can vary significantly, but a main purpose of it is to dispose one or more of the short-throw projector 3, the camera 5 and the illuminant 6 in a proper distance to a screen and to mount on the wall 11 preferably above a displayed picture 12. The displayed picture 12 also represents the coordinate plane 12 and is preferably projected onto a smooth and white surface suitable for projection, pen operation and touching, while in the case of using a flat display the interaction surface 12 is the display itself, optionally protected with a special transparent material in typically glass or plastics material for protection, such that it is robust for pen and touch operation. The data projector 3 has a field-of-view 9 and is operable to project the displayed picture 12, as represented by the solid line rectangle within an interaction volume 1.

An object 2 which, for example, is the user's finger and/or hand can interact with a computer or similar within the interaction volume 1 limited by a particular height over the coordinate plane. There is included a mirror arrangement 7 of at least one off-axis substantially parabolic element outside the interaction volume 1 with its axis parallel to the coordinate plane and its parabolic focal point at the camera's entrance pupil to provide a constant magnification of the volume's height dimension along its axis.

The camera 5 has a field-of-view 8 which includes the interaction volume 1 and the mirror arrangement 7, such that the object's coordinates and the object's hover height can be calculated and/or its hovering condition and/or touch condition and/or the posture characteristics can be derived based on a single image processed by the computational unit, and/or the object's movement and/or the object's gestures can be further calculated based on a sequence of images processed by the computational unit, where the computational unit typically, but not necessarily, is embedded into the camera 5. The camera 5 may have optical filters to selectively block out light of different wavelength ranges, for example, to reduce the influence of daylight and light from the display. The camera 5 may also be equipped with a bi-focal lens to magnify the mirror arrangement 7 on the expense of its surroundings thus increasing the resolution of the imaging of the mirror arrangement 7 in the camera 5 sensor pixel array.

The computational unit has communication means, for example a microcontroller, for transferring the coordinates and the other interaction data to a computer, by, for example, using some serial bus standard and circuits (like USB) or by using wireless communication protocols and devices.

The illuminant 6 can be directive and switchable, thus illuminating the object 2 either directly or through the mirror arrangement 7, such that a most appropriate illumination can be selected for the lateral positioning and the hover height determination, respectively; For lateral positioning of the object, illumination through the mirror arrangement 7 may be preferable because of the formation of a mainly constant height field of light rays parallel to the plane which will illuminate the object from the side when entering the interaction volume and thus also providing some contouring of the object 2 when observed directly from the camera 5. In contradistinction, for the determination of hover height, direct illumination may be more attractive (than illumination through the mirror arrangement 7) thus separating the optical paths for the illuminant 6 and the camera 5, to maximize the signal-to-noise ratio, and further providing some contouring of the object 2 when observed through the mirror arrangement 7. In some exemplary configurations, the sideway illumination can also be done by a substantially similar mirror arrangement, which is separated from the mirror arrangement 7 adapted to be optimized for the observation to get the best signal-to-noise ratio for the combination of sideway illumination and sideway observation.

In all the exemplary configurations and preferred embodiments according to the present invention, there may further be included at least one outer shield or chassis, omitted here for clarity of the figures, but which may enclose one or more of the hardware components: the projector 3, the camera 5 (including the computational unit and communication means), the illuminant 6, the wall mount 4, the mirror arrangement 7 and the display and coordinate plane 12. The purpose for the outer shield or chassis may, for example, be to make the interaction system robust, maintenance-free, dustproof, user-friendly, safer, easier to manufacture, simpler to install, and to present the system with a professional look according to some given principles and elements of design.

Referring further to FIG. 1 and FIG. 2, the mirror arrangement 7 of off-axis substantially parabolic elements is in this exemplary configuration disposed in a mainly semi-circular curvature above the coordinate plane and display 12 preferably either mounted on the wall 11, on the projector mount 4 or on the surface extending the coordinate plane and display 12. In this preferred embodiment the mirror arrangement 7 may be an integral part of the wall mount or an integral part of the complete interactive whiteboard. The mirror arrangement 7 may also be included in a retrofit kit for upgrading an existing whiteboard or short throw projector installation to become touch-sensitive.

Referring to FIG. 1B and FIG. 2B, the configuration illustrated here is similar to that as described above for FIG. 1 and FIG. 2, except that the projector 3 and the projector display surface 12 is replaced by a flat screen (LCD, plasma, OLED, rear-projection etc.) for the display 12.

Further referring to FIG. 1B and FIG. 2B, a stand-alone configuration without any display 12 may be utilized for capturing, for example, precisely strokes from a chalk and sponge and finger touch on a traditional blackboard, while captured results are stored in a computer and the input or some interpretation of the input is shown by its normal computer screen or by a connected display or a projector for the reference of the user or/and the audience.

Referring to FIG. 3 and FIG. 4, the mirror arrangement 7 comprises off-axis substantially parabolic elements placed along a straight line outside one edge, preferably an upper edge, of the display and coordinate plane 12. The same properties and functions as described for FIG. 1 and FIG. 2 pertain except for a difference regarding the physical appearance of the mirror arrangement 7.

Referring to FIG. 3B and FIG. 4B, the configuration is similar as described above for FIG. 3 and FIG. 4, except that the projector 3 and the projector display surface 12 are replaced by a flat screen (LCD, plasma, OLED, rear-projection etc.) for the display 12.

Referring to FIG. 5 and FIG. 6, the mirror arrangement 7 comprises off-axis substantially parabolic elements placed in areas of direct line-of sight from the camera 5 to avoid obstacles due to, for example, the projector 3 chassis or wall mount 4, while being outside the display and coordinate plane 12. The same properties and functions as described for FIG. 1 and FIG. 2 pertain except in respect of the physical appearance of the mirror arrangement 7. In some configurations, the projector 3 and the projector display surface 12 are replaced by a flat screen (LCD, plasma, OLED, rear-projection etc.) for the display 12.

Referring to FIG. 7 and FIG. 8, the same properties and functions as described for FIG. 1 and FIG. 2 pertain except that the system is not mounted for vertical use on a wall but rather mounted for horizontal use on a table surface 12.

Referring to FIG. 7B and FIG. 8B, the configuration is similar as described above for FIG. 7 and FIG. 8, except that the projector 3 and the projector display surface 12 are replaced by a flat screen (LCD, plasma, OLED, rear-projection etc.) for the display 12.

Referring to FIG. 9 and FIG. 10, the same properties and functions as described for FIG. 3 and FIG. 4 pertain except that the system now is adapted for a semi-transparent rear-projection screen 12, such that the camera 5, the illuminant 6, the projector 3 and the wall mount 4 are behind the wall 11, whereas the mirror arrangement 7 of off-axis substantially parabolic elements along a straight moulding is mounted above the projection screen 12 on the wall to observe the interaction volume 1 at a certain given height over the display and coordinate plane 12.

Referring to FIG. 9B and FIG. 10B, the configuration is similar as described above for FIG. 9 and FIG. 10, except that the projector 3 and the projector display surface 12 are replaced by a semi-transparent flat screen (OLED etc.) for the display 12.

Referring to FIG. 11 and FIG. 12, the same properties and functions as described for FIG. 9 and FIG. 10 pertain except that the system is not mounted for vertical use on a wall but rather mounted for horizontal use on a table surface 12.

Referring to FIG. 11B and FIG. 12B, the configuration is similar as described above for FIG. 11 and FIG. 12, except that the projector 3 and the projector display surface 12 are replaced by a semi-transparent flat screen (OLED etc.) for the display 12.

Referring to FIG. 13 and FIG. 14, the same properties and functions as described for FIG. 11 and FIG. 12 pertain except that the mirror arrangement 7 of off-axis substantially parabolic elements is organized along a circular shape, for example, above a top side of the projector display area for a rear-projection system mounted in a table, or organized in elements in areas of direct line-of-sight from the camera to avoid obstacles but outside the display area.

Referring to FIG. 13B and FIG. 14B, the configuration is similar as described above for FIG. 13 and FIG. 14, except that the projector 3 and the projector display surface 12 are replaced by a semi-transparent flat screen (OLED etc.) for the display 12.

Referring to FIG. 15 and FIG. 16, the same properties and functions as described for FIG. 9 and FIG. 10 pertain except that the mirror arrangement 7 of off-axis substantially parabolic elements is organized along a circular shape, for example, above the top side of the projector display area 12, or organized in elements in areas of direct line-of-sight from the camera 5 to avoid obstacles but outside the display area 12.

Referring to FIG. 15B and FIG. 16B, the configuration is similar as described above for FIG. 15 and FIG. 16, except that the projector 3 and the projector display surface 12 are replaced by a semi-transparent flat screen (OLED etc.) for the display 12.

Referring to FIG. 17, the same properties and functions as described for FIG. 9B, FIG. 10B, FIG. 11B and FIG. 12B pertain except that the interactive system is adapted to be mounted in a handheld device.

Referring to FIG. 18, typical images for some exemplary configurations according to the preferred embodiments of the present invention are illustrated, wherein the mirror arrangement 7 of off-axis substantially parabolic elements is organized (a) along a circular shape as in FIG. 1, FIG. 2, FIG. 1B, FIG. 2B, FIG. 7, FIG. 8, FIG. 7B, FIG. 8B; (b) along a straight moulding parallel to an edge of the coordinate plane 12 as in FIG. 3, FIG. 4, FIG. 3B, FIG. 4B; (c) along elements in areas of direct line-of-sight from the camera 5 to avoid obstacles as in FIG. 5 and FIG. 6; (d) along two, three or four straight mouldings parallel to the edges of the coordinate plane 12 which may provide multiple views of the object 2; (e) along a straight long moulding parallel to the upper edge of a very wide coordinate plane 12 covered by the viewpoints of several cameras 5; (f) along one or more elements in areas of direct line-of-sight from the cameras 5 to avoid obstacles and which may provide multiple views of the object 2. This configuration may also be applicable in interactive signage and in interactive posters in exhibitions and museums, where several interactive areas or islands may be established between areas with, for example, three-dimensional structures with informational content which the user can interact with.

Referring to FIG. 19, a parabola with focal point

$$y = \frac{{x}^{2}}{2 p}$$

described by the equation

$$\frac{p}{2} ,$$

and an example of an off-axis substantially parabolic element (above the hatched area and inside the dashed oval) is shown.

Now, example numerical values will be provided for a semi-circular mirror arrangement 7 of parabolic elements for a camera 5 with entrance pupil placed x=510 mm away from the display 12, and with an outer radius of R=150 mm, and a height of H=50 mm (meaning that an interaction volume 1 with height 50 mm can be observed through the mirror arrangement 7). The focal point is

$$\frac{p}{2} = \frac{- R + \sqrt{{R}^{2} + {D}^{2}}}{2} = \frac{- 150 + \sqrt{{150}^{2} + {510}^{2}}}{2} ≅ 190.8 mm$$

The distance R-r from the outer radius as a function of the actual height h of the parabolic element surface, where R is outer radius and r is actual radius, can be found for some height h values, as following:

| h | 50 | 40 | 30 | 20 | 10 | 0 |
|---|---|---|---|---|---|---|
| R-r | ≈63.55 | ≈51.36 | ≈38.91 | ≈26.20 | ≈13.23 | ≈0 |

Referring to FIG. 19B, an exemplary mirror arrangement 7 is shown relating to the above numerical example, wherein the off-axis concave parabolic elements are arranged in sector of 176° of a circle with outer radius of 150 mm. The mirror arrangement 7 is of height 0-50 mm, while the overall height of the unit is 60 mm. The part can be moulded in ABS plastic and metalized by aluminum and protected by a thin polymer layer to avoid degradation by oxidation. Alternatively, a sheet of metalized plastics material can be glued to the part, but then the correct double-curved surface is not feasible to form.

Referring to FIG. 19C, the shape of a sheet of metalized plastics material for the exemplary mirror arrangement 7 as described in FIG. 19B and related to the above numerical example.

Referring to FIG. 19D, a perspective drawing of the exemplary mirror arrangement 7 as described in FIG. 19A, 19B and 19C is shown. The mirror arrangement 7 is adapted to be placed directly on the surface extending the coordinate plane 12 or at the same level mounted on the wall 11 or the wall mount 4.

Referring to FIG. 19E, an exemplary mirror arrangement 7 may be designed which due to some manufacturing limitations in a given case only allow the mirror surface to be single curved. FIG. 19E is an illustration the different shape of the ideal off-axis parabolic function and this linearized off-axis parabolic function. The slope for the single curved surface is adapted to be almost correct at height-0, meaning that the reading of the “final touch” at h=0 will be rather correct. For the mirror arrangement 7 with ideal parabolic function, the reading through the mirror of the object's height over the coordinate plane 11 will be directly a linear function and independent upon the actual (X,Y) location in the interaction volume 1, while for the mirror arrangement 7 using such a manufactured non-ideal parabolic function the reading of object's height will have to be corrected by a (X,Y) location dependent error term, for example, implemented by a look-up table.

Referring to FIG. 19F, an exemplary mirror arrangement 7 is designed which due to some manufacturing limitations, for example, is restricted to have two single curved surfaces, namely the two linear sections in order to approximate the off-axis concave ideal parabolic shape. The figure illustrates the difference in shape between the ideal off-axis parabolic function and the off-axis substantially parabolic function having two linearized sections. These shape artifacts will distort the image of the object, since the deflection angles are not correct. In general, it is feasible due to, for example, manufacturing limitations to utilize different linearized, segmented or other approximated functions to approximate the ideal off-axis concave parabolic function as, for example, of FIG. 19A, and such resulting off-axis concave substantially parabolic element can provide sufficient image quality for observing the object and determining the object's hover height with a sufficient accuracy according to given system requirements, adapted well to the sensor's finite image resolution and the camera's given lens quality.

Referring to FIG. 20, exemplary configurations of the mirror elements according to a preferred embodiment of the present invention: (a) a mosaic of small off-axis substantially parabolic mirror segments; (b) mirror-like metalized plastics material films glued to a base; (c) mirror by utilizing total internal reflection in glass or plastics material; (d) mirror by utilizing total internal reflection in glass or plastics material and using metallization for protection and extension of the mirror function for smaller angles than the critical angle for total-internal reflection; (e) mirror by utilizing a flat mirror and one or more Fresnel lenses for providing the required curvature for the off-axis substantially parabolic function when the camera is in front of screen (front-projection); (f) mirror by utilizing a flat mirror and one or more Fresnel lenses for providing the required curvature for the off-axis substantially parabolic function when the camera is behind the screen (rear-projection or “looking through” transparent flat screen, for example, OLED); (g) mirror by utilizing Fresnel-like segments for the off-axis substantially parabolic function equivalently with (e) and (f);

Referring to FIG. 21A, a flow diagram provides a illustration of an exemplary methodology that facilitates finding fingers' distance to surface, finding fingers' three dimensional coordinates within volume, and the touch and hovering status. The off-axis substantially parabolic mirror elements represent an alternative viewpoint for observing the objects, and the mirror elements explicitly represent the hover level or height or the orthogonal distance Z of the object above the interaction surface within the interaction volume. Simple image acquisition and feature extraction as depicted in box FIG. 21A can find the candidate object positions within the two regions of interest in the camera image array, namely within the direct, or synonymously the front, viewpoint and the mirror viewpoint. For each view a solid angle which the candidate object subtends at the camera's entrance pupil can be found. In the mirror view, the height Z over the interaction surface (12) is found explicitly and the correspondence problem related to match one or more points in the three dimensional space by two observation and image processing of two different two-dimensional views will be substantially simplified.

FIG. 21B is a flow diagram illustrating a speed-up methodology for finding an object. In this example the mirror arrangement 7 is a semi-circular off-axis substantially parabolic mirror section as, for example, is illustrated in FIG. 19B to 19D, and with a typical image FIG. 18A, where an object is seen both through the mirror and directly.

The height Z and the angle AZIMUTH for an object (2) can be observed by the camera through the mirror representing a straight line trajectory in the coordinate system of the interaction volume (1). This straight line in the three-dimensional interaction volume (1) represents all the possible (X-Y) positions the object (2) can have for the given Z and AZIMUTH. This three-dimensional trajectory is by the coordinate transformation for the lens mapped to a two-dimensional trajectory in the camera pixel array which for example can be found by a look-up table, and this trajectory can be traversed starting from the end closest to the mirror and with a certain pathwidth given in number of pixels an edge detector algorithm can find a candidate object. Then detailed sub-pixel edge detection or template matching can be performed to find the pixel position (x-y) with higher accuracy, and then transformed by an inverse coordinate transformation by, for example, a look-up table, the candidate object's coordinates with high accuracy (X-Y) in the surface volume coordinates are calculated. Finally, after this search algorithm, the X,Y,Z and posture information can be reported as described.

Compared to a full search algorithm in the two-dimensional pixel array with a edge-detector algorithm, which is computational complexity is proportional with the size of the array of interest covering the interaction volume (1), the described algorithm is much less complex, and is substantially proportional with the length of the diagonal of the array, such that the speed-up factor may be substantial, in the range of 100×-1000×, dependent on the resolution of the sensor and the area of interest.

Referring to FIG. 22, exemplary methodologies are given that facilitate calibration of the camera to the display screen, according to a preferred embodiment of the present invention, wherein (a) is a standard manual calibration approach where crosses are presented on the display screen and an operator uses a pen or the finger to touch each cross in a given sequence; (b) is a automatic calibration approach using patterns like in the inventions WO2001NO00369/U.S. Pat. No. 7,083,100B2 and/or WO2006135241A1/US2009040195A1 to identify the different calibration points, these inventions being hereby incorporated by reference; (c) is a semi-automatic calibration approach using patterns like in (b) first to identify the different calibration points, then presenting a set of white circular discs on a black background in given locations in which the operator disposes in a given sequence a semitransparent cylinder with internal opaque or reflective material, such that the touch detection limits can be set or controlled.

Referring to FIG. 23, exemplary configurations of (a) a pen with tracking patterns 13; (b) a mirror with localization control patterns 13; and (c) a coordinate plane with localization control patterns 13; used together with the present invention, are shown. The patterns may be, for example, patterns used for identification and tracking of objects as in WO2001NO00369/U.S. Pat. No. 7,083,100B2 and/or WO2006135241A1/US2009040195A1, US2009040195A1, hereby incorporated by reference. Referring further to FIG. 23, using such patterns and pattern recognition, the pen input can be distinguished from other interaction input devices like a human finger, such that dual-mode input systems can easily be implemented by the present invention and the actual referred inventions. Referring further to FIG. 23, the interaction surface and the mirror can also be equipped with such patterns, such that automatic control, calibration and self-adjusting set-up can be realized by utilizing the present invention with the other referred inventions.

Referring to FIG. 24, exemplary configurations of providing a controlled background for the imaging and measurements by using a small moulding or list 15 along one or more edges of the coordinate plane, typically being white, black or having a retro-reflective optical property 14 in the actual near-infrared wavelength range. In this example, the moulding/list is also serving as a pen shelf 15 beneath the coordinate plane.

Referring to FIG. 25, exemplary configurations of a mirror arrangement of off-axis substantially parabolic elements at the coordinate plane are shown adapted to detect the object's height above the plane, while additional curved or flat mirror elements 16 further outside the off-axis substantially parabolic mirror elements are adapted to provide spatial information of the scene when these mirrors are observed from the camera's viewpoint. This exemplary configuration can enhance the ability to follow and determine the posture and gestures of objects 2 also outside the interaction volume 1 by observing the objects 2 in the mirrors 16. Also, in a more advanced human-computer interaction scenario, the user gestures and behavior can be analyzed by observing the direct view and the view in the mirrors 16 to forecast new interaction events. The three-dimensional position and posture of the object 2 can also be estimated.

Referring to FIG. 26, exemplary configurations of a mirror arrangement of off-axis substantially parabolic elements at the coordinate plane are shown for the observation of object's height relative to coordinate plane, combined with other illumination apparatus 17 for providing illumination, such that the mirror arrangement 7 itself for the observation the object's height over the coordinate plane are less exposed to the direct illumination, thus reducing unwanted reflections of the optical interfaces and by that increasing the signal-to-noise ratio of the measurements.

Referring to FIG. 27, a system is shown comprising a display 12, a cooperating computer 18 and the apparatus 19 according to the present invention, and the communication means 20 between the cooperating computer and the display 12 and the communication means 21 between the cooperating computer and the present apparatus 19 according to the present invention. The communication means 20 is optionally implemented as a wireless data link and/or a direct cable-connected link and/or an optically modulated link.

Referring to FIG. 28, shows an exemplary configuration according to a preferred embodiment of the present invention, where the direct view and the mirror view are captured by two cooperating, separated image sensors 23 and 24, respectively, with separate optics to optimize each view for low cost, miniaturization and simple set-up, and connected through, for example, a high speed serial link 22. The dashed line 10 indicates that one or more of the different components may be enclosed by a chassis 10. A separated illumination unit 17 as shown in FIG. 26 may also be included in such chassis 10. However, the components can also be separated and be modular for retrofitting an existing projector installation to make it interactive or, for example, upgrade a pen-based interactive whiteboard to be touch-sensitive. Optionally, lens optics are used which are best suited for the two separate views, and then executing the same computations on the pair of images by the computational unit. The speed-up scheme described in FIG. 21B for the present invention will also apply with same speed-up potential in such dual sensor/lens configuration.

Referring to FIG. 29, a redundant scheme for finding the interaction object (2) and touch and hovering state in case of occlusion in the direct camera view, is inspired by the speed-up procedure described in FIG. 21B applied on, for example, two mirror arrangements 7: mirror M1 and mirror M2, wherein a distance between the mirrors M1 and M2 is a baseline L as shown. Correspondingly to methods in FIG. 21B, one may find the azimuth a and height Z1 for object P by observing the mirror M1 and the azimuth β and height Z2 for an object P by observing the mirror M2, and by triangulation finding the object position (X-Y) in the interaction surface 12 or interaction volume 1.

The two mirrors M1 and M2 are located with a distance L apart, i.e. the baseline is L. Then the distance d from baseline of length L to the target P is:

$$d = \frac{L}{\frac{1}{tan α} + \frac{1}{tan β}}$$

The distance d can also be expressed as:

$$d = \frac{L \cdot sin α \cdot sin β}{sin ( α + β )}$$

The X and Y coordinates can be simply derived by simple trigonometric calculations.

By coordinate transformation or by a look-up table the corresponding sensor image (x-y) position can be found and a detailed image analysis can be done locally in the image in a neighborhood around the (x-y) position to get a more accurate positioning, which by coordinate transformation or look-up table can be transformed to a corresponding accurate (X-Y) position in the interaction surface (12) or interaction volume (1) coordinate system.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

1. An apparatus for determining a position or posture or both of at least one, wherein the object is in whole or partly located within an interaction volume delimited by an interaction surface and by a certain height range in a height dimension over said interaction surface, comprising
camera;
a mirror arrangement comprising one or more mirror sections;
a computational unit for the computation of position and posture or both of at least one object based on information from the camera inter alia;
wherein the camera is arranged to include both the volume and the mirror arrangement within the camera's field-of-view;
the mirror arrangement, where the one or more mirror sections comprises at least one off-axis concave substantially parabolic optical mirror element at the plane of the interaction surface and where each off-axis substantially parabolic optical mirror element is arranged with its focal point at the camera's entrance pupil and its axis parallel with the surface, such that a view of the volume is produced with constant magnification of the height dimension for each substantially parabolic optical mirror element along its axis;
such that the object's position and/or posture is determined by the computational unit based on information of a single picture from the camera.

2. The apparatus according to claim 1, comprising only one camera.

3. The apparatus according to claim 1, wherein at least one second object is within the camera's field of view but not necessarily within the volume, where the posture of the at least one second object is determined, such that the posture of the second object may provide additional information.

4. The apparatus according to claim 1, wherein the off-axis concave substantially parabolic optical mirror element comprises Fresnel like mirror element providing a off-axis concave substantially parabolic mirror function.

5. The apparatus according to claim 1, wherein the off-axis concave substantially parabolic optical mirror element comprises a mirror element and a lens element arranged in combination for providing the off-axis substantially parabolic mirror function.

6. The apparatus according to claim 5, wherein the mirror element is linear.

7. The apparatus according to claim 5, wherein the lens element is a Fresnel lens.

8. The apparatus according to claim 1, wherein the mirror element comprises a reflective surface where reflection is provided either by a metalized plastics material film, metalized plastics material injection-moulded parts, by total internal reflection or by total internal reflection combined with metallizing.

9. The apparatus according to claim 1, wherein the mirror element comprises a layer of plastics material and/or special coating which selectively stops or passes light within given wavelength ranges allowing, for example, the mirror element to be functional in the near infrared light with reduced reflections of visual light.

10. The apparatus according to claim 1, wherein at least one mirror section is adapted to be arranged in an exterior of an periphery of the interaction surface.

11. The apparatus according to claim 1, wherein at least one mirror element is arranged in a straight moulding along an exterior of an edge of the interaction surface.

12. The apparatus according to claim 1, wherein the at least one mirror elements is distributed in a semi-circular shape adapted to be arranged at a wall or table mount.

13. The apparatus according to claim 1, wherein the mirror arrangement comprises a plurality of mirror sections and the mirror sections are arranged for providing multiple views of the object.

14. The apparatus according to claim 13, wherein the mirror elements are arranged in a mosaic structure for reducing shading and enhancing mirror-to-pixel mapping characteristics.

15. The apparatus according to claim 1, comprising a plurality of cameras, wherein the cameras are arranged to provide multiple views of the at least one object, and in areas of direct line of sight from the cameras to avoid shading.

16. The apparatus according to claim 1, wherein at least one camera is arranged with a bi-focal lens to magnify the view of the at least parts of the mirror arrangement.

17. The apparatus according to claim 1, wherein at least one camera comprises at least one optical filter to block out or pass light at a selected wavelength such that unwanted light is stopped while allowing light in the wavelength range of the illumination to pass.

18. The apparatus according to claim 1, wherein at least one camera comprises at least one selectable optical filter for selectively blocking out or passing light at different wavelength ranges such that, for example, light with the same wavelength as the illumination or visual light is blocked out or passed.

19. The apparatus according to claim 1, comprising an illumination arrangement arranged to provide illumination of at least parts of the interaction volume with visual and/or near infrared light, directly and/or indirectly via the mirror arrangement.

20. The apparatus according to claim 19, wherein the illumination arrangement is controlled to turn the illumination on and off and/or to provide flashing within an active exposure period of the camera to freeze motions of the one or more objects.

21. The apparatus according to claim 19, wherein the illumination arrangement is arranged in a proximity of the camera's entrance pupil, namely close to the focal point of the off-axis substantially parabolic elements, and illuminating indirectly through the mirror arrangement such that the illumination is spread in the interaction volume with rays substantially parallel to the interaction surface.

22. The apparatus according to claim 19, further comprising a separate, second mirror arrangement arranged to contribute to illuminating the interaction volume such that the mirror arrangement for observation is less exposed to illumination thereby increasing a signal-to-noise ratio of measurements performed using the apparatus.

23. The apparatus according to claim 19, further comprising a separate, second illumination arrangement arranged to contribute to illuminating the interaction volume, thereby increasing a signal-to-noise ratio of the measurements performed using the apparatus.

24. The apparatus according to claim 19, wherein the illumination arrangement is operable to provide for direct illumination and for indirect illumination through a mirror arrangement and wherein the direct and indirect illumination is controlled separately to improve detection of the one or more objects.

25. The apparatus according to claim 19, wherein the illumination system is operable to change an appearance of the object, for example, by projecting a colored and/or flashing illumination as interaction feedback to a user from a computer.

26. The apparatus according to claim 1, further comprising additional curved or flat mirror elements adapted to provide spatial information when observed from the camera.

27. The apparatus according to claim 1, comprising two mirror sections arranged at a distance to allow finding the position or the posture or both of an object by triangulation, such that said position or posture or both also is determined in a case of occlusion in the direct camera view of the object.

28. The apparatus according to claim 1, wherein lens optics is separated for direct view and view through the view through the off-axis substantially parabolic mirror elements by utilizing one or more separate sensors.

29. An interaction system for providing interactive use of an object in a proximity of a presentation surface, wherein the interaction system comprises an apparatus for determining position and/or posture according to claim 1, wherein the interaction system further comprises presentation devices arranged to present images at the presentation surface.

30. The interaction system according to claim 29, comprising a front-projection screen, wherein the camera, the illuminant, the projector are arranged on the same side of the screen as the interaction volume.

31. The interaction system according to claim 29, comprising a semi-transparent rear-projection screen wherein the camera, the illuminant the projector are arranged on the opposite side of the screen to the interaction volume,

32. The interaction system according to claim 29, comprising a semi-transparent flat screen, for example, OLED, wherein the camera, the illuminant are arranged on the opposite side of the screen to the interaction volume.

33. The interaction system according to claim 29, wherein the interaction surface is arranged at a wall, a table or a handheld device.

34. The interaction system according to claim 29, wherein the interaction system comprises attachment means for the projector and wherein at least one mirror arrangement is arranged in connection with the attachment means such that near optimal positioning of different components of the system is facilitated.

35. A method of determining a position or posture or both of at least one object, wherein the object is in whole or partly located within an interaction volume delimited by an interaction surface and by a certain height range in the height dimension over the said interaction surface comprising the steps of:
reflecting radiation from an object within a volume in the proximity of within the interaction volume using a mirror arrangement comprising at least one off-axis concave substantially parabolic optical mirror element at the plane of the interaction surface, and where each off-axis substantially parabolic optical mirror element is arranged with its focal point at the camera's entrance pupil and its axis parallel with the surface such that a view of the volume is produced with constant magnification of the height dimension for each substantially parabolic optical mirror element along its axis;
recording reflected radiation by a camera arranged to include both the volume and the mirror arrangement within the camera's field-of-view;
transferring information from the camera to computing means; and
computing position and posture or both of at least one object based on information from the camera inter alia.

36. A method of calibration and control in the height dimension over an interaction surface for precise touch and hovering information comprising the method for determining the position or posture or both according to claim 35, further comprising:
placing a semi-transparent three-dimensional pattern test object on the interaction surface;
highlighting the interaction surface in circular areas one by one;
observing the test object directly and seen from the side through the mirror arrangement by the camera;
identifying the pattern of the test object;
calibrating and mapping from coordinate plane's coordinates to interaction surface coordinates and/or calibrating the height measuring; and
determining thresholds for touch and hovering.

37. A method for finding an object's, where the object may be a finger, distance to a surface, three dimensional coordinates and touch and hovering status, comprising the method for determining the position or posture or both according to claim 35, further comprising:
performing a standard image acquisition and feature extraction;
finding solid angles which a tip of the finger subtends at the camera's entrance pupil in front view and in mirror viewpoint;
finding the fingers' distance to surface by using a direct linear model if the mirror is a parabola or else a parabolic approximation model;
finding the fingers' three-dimensional coordinates based on the solid angles and the distance to the surface; and
finding hover/touch status of the finger by comparing distance to surface with threshold values.

38. A method of speeding-up a computation and a search for tracking objects in an interaction volume comprising the method for determining the position or posture or both according to claim 35 further comprising:
performing a standard image acquisition of an image and feature extraction within the sub-image including the mirror arrangement;
finding the object's distance to surface and the effective observation angle of parabolic mirror element along the interaction volume;
finding a straight line in the three-dimensional interaction volume representing all the possible (X Y) positions the object;
finding a corresponding two-dimensional trajectory in the camera pixel array, for example via a look-up table;
traversing this trajectory with a certain pathwidth with an edge detector and finding a candidate object in array position;
performing detailed edge detection or template matching to find an accurate array position;
finding a corresponding X-Y position, when Z is known; and
reporting one or more of X,Y,Z and touch and hover information to a computer.
